(19) United States
(12) Patent Application Publication
(10) Pub. No.: US 2015/0058390 A1
(43) Pub. Date: Feb. 26, 2015

(54) Storage of Arbitrary Points in N-Space and Retrieval of Subset Thereof Based on a Determinate Distance Interval from an Arbitrary Reference Point

(71) Applicant: Matthew Thomas Bogosian, Marina, CA (US)

(72) Inventor: Matthew Thomas Bogosian, Marina, CA (US)

(21) Appl. No.: 13/970,929

(22) Filed: Aug. 20, 2013

(51) Int. Cl. G06F 5/00

(52) U.S. Cl. CPC G06F 5/00
USPC 708/442

(57) ABSTRACT

Systems and methods pertaining to nearness calculations of points in n-space. Among the embodiments is associating points of interest with point records in a data store, and efficient retrieval of subsets of those point records which meet arbitrary criteria. Criteria can limit retrieval to neighbors of a reference point (i.e., point records associated with points of interest whose home cells that share at least one interface with another designated home cell). Computationally expensive, at-retrieval range calculations are avoided by performing complimentary calculations at-storage and saving them with related records. The invention is appropriate for use with data storage mechanisms which limit inequality or range operations, or for which such operations result in inefficiencies. When used to model neighboring points on a planetary surface in 3-space, the invention does not suffer from polar distortion (where spherical coordinate systems have difficulty).

### PRIORITY CLAIM

This application is a continuation-in-part of U.S. utility application Ser. No. 13/970,755 filed on Aug. 20, 2013, which is a continuation of U.S. utility application Ser. No. 13/046,740 filed on Mar. 12, 2011, which claims priority to U.S. provisional application 61/313,733, filed Mar. 13, 2010. This application includes all applications mentioned in this paragraph by reference as if fully set forth herein.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### TECHNICAL FIELD

Related technical field(s) are: digital communication, computer technology, measurement.

### BACKGROUND ART

Despite the continued momentum of Moore's assertion, the efficiency of calculations and data storage still remain relevant in today's world of computation. As the prevalence of computational capacity increases, problems of greater complexity are attempted which in turn demand additional capacity. Sometimes entire markets are discovered (see for example the cyclical race between special-purpose spatial calculation and rendering hardware and its use in video game consoles and film production).

Shared computation resources such as Amazon's Infrastructure Services or Google's App Engine are becoming more popular. With such services, resource-intensive computations can literally be quite expensive. Fees typically grow in proportion to the number of cycles consumed or amount of data stored per billing period. In addition, processes that exceed resources ceilings face termination. Designs allowing more complex computations within such limitations are often nontrivial. New algorithms that reduce (rather than divide and distribute) complexity require rare expertise.

Efficiently searching through large data sets remains an important part of displaying relevant and targeted content to consumers of that data. Consumers demand and expect such targeted content to be readily available.

The importance of geo location data has grown with its pervasiveness. An increasing number of today's mobile products can “know where they are” either via satellite or signal triangulation. Such features are rapidly becoming standard in today's consumer communication devices. These devices are becoming more sophisticated in their abilities to produce content (e.g., digital photographs, images, video, etc.) as well as display it. The number of consumers of those devices is increasing as well.

Encoded in much consumer-produced content is the geo location data of the device at the time the content was created. This geo location data can be used to identify the content with a location. For example, a digital photograph contains not only the image itself, but may also contain the date, time and location of creation.

The ability to store vast libraries of digital content currently exists. However, consumers demand increasingly complex views into that content. For example, a consumer with a mobile device may want to publish a photograph taken in a location. Another consumer may want to compare that photograph with other published photographs taken near that same location. A tourist may want to see reviews for local restaurants, focusing on the most recent.

Despite the increasing sophistication of applications and services making use of this content, the ability to efficiently identify and retrieve such subsets is limited. Existing methods are computationally expensive and unsophisticated, and are hence ill-equipped to meet the projected demand.

Spherical coordinate systems may seem seductively obvious for ellipsoid planetary surfaces, but (as many have observed) the pitfalls are many:

The traditional angular measurements of latitude and longitude are extremely unsuitable for automated computations. Few, if any, spatial problems can avoid multiple evaluations of trigonometric functions.⁶ ⁶ Lukatela, H. (1987, March 8). “Hipparchus Geopositioning Model: an Overview”. Geodyssey Limited. Retrieved from <http://www.geodyssey.com/papers/hlauto8.html> on Jan. 5, 2010.

Such systems do not lend themselves to accurate distance and area calculations:
Various schemes based on latitude/longitude “rectangles” are often used for large coverage or global databases. However, resulting cell network [sic] is hard to modify in size and density, high-latitude coverage can be restricted or inefficient, and in most cases the approach forces the use of unwieldy angular coordinates.⁷ ⁷ Lukatela, 1987.

In other words, approximating nearness using a latitude range and a longitude range may be adequate near the equator, but the same approach becomes distorted and impractical as one approaches the poles.

In addition, while most modern relational database systems' indexing capabilities are sufficient for dealing with arbitrary ranges, not all data storage systems perform well (or at all) with such models. Berkeley DB, for example, requires maintaining such indexes manually. Google's App Engine does not allow selections on ranges of more than one property.

Some have suggested using Morton numbers for latitude/longitude pairs (also known as Geohashes) to make coordinate range searches possible within such limitations. (Hitching 2009.) However, that approach does not allow for additional range variables. For example, designing a query to retrieve the five most recent reviews of restaurants within a given radius of a latitude/longitude pair would not be possible using such a model. Even so, “Mortanizing” spherical coordinate components does not avoid computationally expensive trickery to avoid polar distortions and other problems.

Accordingly, it would be desirable to have innovative mechanisms that allow for not only the storage and retrieval of such content, but that would also allow efficient retrieval of subsets based on criteria relevant to the location of that content and/or the consumer of that content.

### Conventions Used in this Application

This application uses several conventional mathematical notations to convey certain concepts. Variables are generally denoted by italicized lowercase letters (e.g., “n”). As is common, points in n-space are frequently represented herein as vectors of n components. Vectors are denoted interchangeably by bold italicized lowercase letters or italicized lowercase letters with arrows (e.g., “p” and “\vec{p}” are equivalent). Matrices are denoted by bold italicized uppercase letters (e.g., “S”). Components of vectors and matrices are denoted between brackets (i.e., “[ . . . ]”). Sets are denoted by italicized uppercase letters (e.g., “S”). Components of sets are denoted between braces (i.e., “{ . . . }”). Other common notation and symbols are used throughout (e.g., “iff” or “ [symbol] ” for “if and only if”, “Ø” for the empty set, etc.), and will be easily interpreted by a person of ordinary skill.

Additionally, this application discloses several code listings written in pseudocode consistent with commonly-available technologies (e.g., Python, GQL, SQL, etc.). This should not be interpreted as limiting the invention to those technologies. The code listings are limited illustrations of only some of the embodiments. The invention may be implemented in terms of any number of technologies. It does not necessarily rely on those used or identified herein. For example, the invention may be practiced using a relational database, but one is not required. Any number of other methods of data storage could be used. Variations will be apparent to those skilled in the art.

### SUMMARY OF THE INVENTION

The present invention relates to the identification, storage, and retrieval of arbitrary points in n-space. More specifically, the invention relates to computationally efficient retrieval of a subset of points from a data store, where each point is “near” (i.e., within a known range distance of) an arbitrary reference point, and where the reference point is not known until retrieval. In addition, the invention allows for arbitrary data to be associated with each point in the data store, and allows retrieval of subsets of points and associated data based on arbitrary matching criteria. Computationally expensive, at-retrieval range calculations are avoided by performing complimentary calculations at-storage and saving them with related records. For nearness searches of arbitrary latitude/longitude pairs, this is non trivial but possible with forethought as described below.

### Genus: General Approach

The general genus involves dividing a space of interest (e.g.: a volume, like an office building or an ocean; or a surface, like a land mass on a planet) into a set of contiguous shapes or “quanta” which act as “cells” for points in space. Because the shapes are contiguous (i.e., there are no gaps between them), any given point p in the space of interest exists in one “cell” or “quantum” (with special considerations for those points which coincide precisely between two or more cells). The cell containing a particular point p is said to be p's “home” (also known as a “home cell” or “home quantum”, and in prior documents, a “home shape”, “home volume”, “canonical shape”, etc.).

Informally, given two points p and q, p is “near” q if q's home cell is the same as p's home cell, or if q's home cell borders p's home cell. The term “borders” is more formally defined below. The size of the cells is often chosen to suit a specific application. Some applications may use different sets of cells concurrently (e.g., where the shapes or sizes of the cells in one set differs from the other). The cells are usually (though not necessarily) substantially uniform. The important thing is that the set of cells is static (i.e., for a particular set of cells, a given point p will always end up in the same home cell).

There are two main species disclosed herein (each with variations): the first is well-suited to polygons (especially triangles), which may be used to model planes or surfaces, and the second (more general) is well-suited to n-space “volumes” (although, as will be explored, the volumetric species can approximate planar or surface nearness as well).

### Species: Surface Approach

An informal summary of the surface species is as follows. Model a surface of interest as a collection of polygonal cells where the total area of any single cell and its immediately adjacent neighbors approximates a radius of interest. For example, if one were generally interested in collections of points within a radius of approximately 100 km on the surface of the Earth, one could model the surface of the Earth using roughly equilateral triangle cells whose edges were approximately 115.47 km. (See FIGS. 1 and 3, and Eqs. 1-2.)

$$\begin{matrix}\begin{matrix}( prior art ) basic properties of an equilateral triangle , where a is the length of each edge , {r}_{c} is the radius of a circumscribed circle , {r}_{i} is the radius of an inscribed circle , and h is the height \\ {r}_{c} = \frac{\sqrt{3}}{3} a \\ {r}_{i} = \frac{\sqrt{3}}{6} a \\ h = \frac{\sqrt{3}}{2} \\ & \end{matrix} & Equation 1 \\ ( prior art ) finding the edge length of an equilateral triangle whose height h is 100 km \\ 100 km = \frac{\sqrt{3}}{2} a \\ \frac{200 km \sqrt{3}}{3} = a \\ 115.47 \approx a & Equation 2\end{matrix}$$

As one can see in FIG. 3, given a space of interest 100 divided by substantially equilateral triangles, if one fixes the height h 381 of each triangle to 100 km, when one wants to identify points within approximately 100 km of a point of interest p 105, one looks for points 206 in the triangle 203 in which p is found, as well those in each immediately adjacent triangle 205. One can discard or ignore other points 209. Of course depending on where p is within its containing triangle 203, some identified points may be up to twice the edge length a 380 (approximately 230.94 km) away from p (i.e., if p coincides with the vertex of its containing triangle) but one can either discard those points post-identification or select a smaller edge length 380 to better approximate 100 km on average (though one risks excluding some points that are technically within 100 km, but outside of the immediately adjacent triangles). For example, one could select an edge length 380 such that the minimum distance 383 from the center 382 of p's triangle 206 to a “far” edge is 100 km (where rᵢ+h or 2r_{c} is 100 km, or where a is approximately 86.60 km). Alternatively, one could select an edge length 380 such that the maximum distance 384 from the center 382 of p's triangle 206 to a “far” edge is 100 km (where r_{c}+h is 100 km, or where a is approximately 69.28 km).

It may be tempting to carefully approximate a surface of interest using many tiny polygons. However, it can be computationally expensive to discover which polygon “contains” a given point of interest p, because the number of polygons required varies inversely to the radius of interest. For example, for a subdivided icosahedron, the number of surface triangles is 20×m² where m is the number of subdivisions. Assuming one is modeling the Earth (with a mean radius of 6.371 km), and each radius of interest is properly approximated by twice the height of a triangular cell (i.e., r=2h), a radius of roughly 10 km (a useful measurement in many modern applications) requires 305 subdivisions of each face (or 1,860,500 total surface triangles). A radius of 1 km requires 3,054 subdivisions (186,538,320 triangles). A radius of 100 m requires 30,0543 subdivisions (18,657,496,980 triangles). It is not practical to calculate and store the faces of such complex solids ahead of time. Even if it were, checking intersections with each sub-face would likely take months or years. Most applications require access to multiple subdivisions. Therefore, a method calculating intersections at arbitrary subdivisions at run-time must be made available if the home cell approach is to work.

There are certainly model-specific optimizations which can be made to avoid an entirely brute-force approach (e.g., by grouping sets of contiguous polygons, and identifying if p is within that group, and then recursing through progressively smaller subgroups), but they remain relatively computationally expensive and may require addressing (sometimes many) edge cases (literally). For many applications, it is acceptable to model a surface with a much less granular or less detailed shape (or “mesh”) with relatively large, but simple surface shapes, and then rapidly subdivide the surface shapes “on the fly”, as will be discussed.

For example, one application might be to determine surface nearness of points within 10 km of each other on Earth's surface (without concern for altitude). Rather than modeling the surface of the Earth as a mesh of relatively tiny polygons (e.g., substantially equilateral triangles where h is 10 km as described above), one instead starts with a very simple model, like an icosahedron. (See FIG. 6.)

This approach is appropriate for many modern interactive mapping applications and “mash-ups”. In such an environment, the location of a point of interest 105 is often described using spherical coordinate systems like latitude and longitude. Because the model of the surface or space of interest 100 uses a coordinate system that does not suffer from the aforementioned limitations of spherical coordinate systems (e.g., cartesian coordinates), the point of interest 105 may require conversion from its legacy coordinate system to the model coordinate system. For example, latitude/longitude pairs representing locations on the surface of a planetary body with a (roughly) fixed radius is a specialized application of spherical coordinates. Conversion of points in such coordinate systems to cartesian coordinates is well understood. (See Eq. 3 and Code List. 1.)

$$( prior art ) latitude \text{/} longitude coordinate pair as the cartesian vector v \\ φ = rad ( lon ) \\ θ = rad ( lat ) \\ v = [ \begin{matrix}x \\ y \\ z\end{matrix} ] = [ \begin{matrix}r cos ( θ ) cos ( φ ) \\ r cos ( θ ) sin ( φ ) \\ r sin ( θ )\end{matrix} ] \qquad Equation 3$$

Code Listing 1: Pythonic pseudocode for converting spherical
coordinates to a cartesian vector in 3-space

```
import math
def sphere2Cart(a_lat, a_lon, a_radius):
  t = math.radians (a_lat)
  p = math.radians (a_lon)
  x = a_radius * math.cos (t) * math.cos (p)
  y = a_radius * math.cos (t) * math.sin (p)
  z = a_radius * math.sin (t)
  return ( x, y, z )
```

Intersection of a ray with a triangle is also well understood. In the depicted example, an icosahedron 10 is used to model the space of interest 100. One translates the point of interest 105 from its latitude and longitude pair to a cartesian vector. One then constructs a ray 104 from the center 101 of the icosahedron 10 through the point of interest 105. Then one tests each of the faces 102 of the icosahedron 10 to see which face 106 the ray 104 intersects. The intersected face 106 is the one which “contains” the point of interest 105.

Optimizations are abundant. For example, where surfaces of spheres are modeled using regular polygons whose normals are perpendicular to the sphere (e.g., icosahedron 10, dodecahedron 20, truncated icosahedron 30, etc.), others have observed that one could compute the dot product of the normalized point of interest 105 with the normal vectors of each of the faces 102 of the model (which could be computed and stored in advance). This could quickly rule in or out those faces 102 where the point of interest 105 was inside the insphere or outside the circumsphere, respectively, as discussed in more detail in U.S. 61/313,733, to which this application claims priority.

If one were to stop there, the “containing” face 106 is likely too large for an application to glean any meaningful proximity information, especially where one is interested in points within 10 km of the point of interest 105. When considering “nearness” as loosely defined above, one would include points not only in the containing face 106, but also each neighboring face, which would include half of the surface of the model, which is hardly useful for most applications.

Instead, as discussed formally below, one immediately subdivides the containing face 106 into predictable cells 201 sized to achieve a radius of interest. In U.S. 61/313,733, to which this application claims priority, several specific approaches are compared and explored. Among the most promising is “Quantized Barycentric Triangulation”, which is revisited below.

Note that many different polyhedron meshes could be used to model a spheroid surface. (See FIG. 5 for some examples.) Some work better than others, however. The icosahedron 10 is seductive because its faces are few and uniform, and they are triangles. Thanks to the computer graphics industry, many computational optimizations and discoveries have been made that are specifically directed toward triangles as the simplest planar polygons, ubiquitous in three-dimensional modeling and rendering. A similar option is a pentakis dodecahedron 40 (depicted as a flattened set of contiguous triangles in the figure), which is slightly more complex, but shares many favorable characteristics to the icosahedron 10. Other possibilities include a dodecahedron 20 and a truncated icosahedron 30 (commonly observed as the stitching pattern on a soccer ball), to name a few. Archimedean solids are generally attractive because of their relative symmetry. Any platonic solid may be appropriate in modeling spheres, but computational complexity will likely increase with the complexity of the number and types of faces.

### Species: N-Space “Volume” Approach

An informal summary of the “volume” species is as follows. Model a space of interest as a collection of contiguous cells, where the total “volume” of any single cell and its immediately adjacent neighbors approximates the “volume” of interest. For example, if one were generally interested in collections of points within a radius of approximately 100 km, one could model the space using uniform cubes whose edges were 100 km. (See FIG. 15.)

As one can see in FIG. 15, if one fixes the edge length 350 of each cube to 100 km, when one wants to identify points within 100 km of a point of interest p 105, one looks for points 206 in the cube 203 containing p, as well as those in each immediately adjacent cube 205. One can discard or ignore other points 209. Of course depending on where p is within its containing cube 203, some identified points may be over three times the edge length (approximately 346.41 km) away from p (i.e., if p coincides with the vertex of its containing cube) but again, one can either discard those points post-identification or select a smaller edge length 350 to better approximate 100 km. For example, one could select an edge length 350 a such that the minimum included distance from the center of p's cube to a “far” face is 100 km (approximately 66.67 km), or such that the maximum included distance from the center of p's cube to a “far” face is 100 km (approximately 38.49 km).

Again, as described above, conversion between coordinate systems may be necessary where the point of interest 105 is described using one system, and the model of the space of interest 100 is described using another. However, computationally, the volume species is often much less complex than the surface species. Practically speaking, for most applications, n-cube-based quantization is an efficient and accurate method of generalized nearness approximation in n-space. The origin may be chosen arbitrarily (e.g., the center of the Earth, the center of the Milky Way, the fire hydrant down the street, etc.), so long as the maximum distance measurements and quantization precisions are efficiently supported by the computation environment.

When the quanta are small relative to the surface to be modeled, surface nearness can be approximated using the volume species as well (if not better than) the surface species. However, care should be taken. In the mapping example, if altitude is taken into account, results may be counterintuitive, especially when modeling large cities with very tall buildings. A query such as “find the closest coffee shop”, when asked from the 50th floor, may favor the cafeteria on the 40th floor of the neighboring highrise over the cafe on the ground floor of one's own.

With both species discussed in this application, variations are possible and tradeoffs should be considered for each application. Note that while the surface species is likely limited to areas (e.g., two dimensional spaces, or approximations of three-dimensional surface areas using two-dimensional polygons), the volume species is not so limited. Use of the word “volume” in this application should not be interpreted as limiting the volume species to three dimensions. The volume species applies equally well to points in any coordinate system with dimensions of any whole number (1, 2, . . . , ∞), and is limited only by computational resources, and the imagination of the modeler or application designer.

### Storage Of Points and Retrieval Of Points “Near” to a New Point

Once a set of cells is defined for a space of interest, one creates a data store for storing points. Storing a point p roughly comprises: determining p's home cell(s); storing p in a point record in the data store; associating p's home cell(s) with the point record; and optionally associating other data pertaining top (e.g., a date, a digital photo taken near p, a URL, commentary regarding something at or close top such as a warning or recommendation, etc.). Each new point record becomes part of the set of all point records Q in the data store.

When one wishes retrieve from Q the subset of point records Q′ whose points are “near” a given point q, the process roughly comprises: determine q's home cell; find all point records Q′ in the data store whose home cell either coincides with q's home cell or borders q's home cell; optionally retrieving some or all of the data associated with each point record in Q′. Subsets are further refined by allowing matching criteria to apply to data associated with the point records in Q′. For example, one could retrieve URLs associated with point records whose points are “near” q and that were created after a particular date and time.

In other words, the novel concept of “nearness” described herein is complimentary to and may be combined with any number of existing data storage and retrieval mechanisms and technologies. For example, the data store could allow modification of data associated with a particular point records or sets of point records, deletion of point records and associated data, sorting of query results, etc. It could also provide access controls governing operations. There are many possibilities.

Many applications and possibilities will become apparent to one skilled in the art upon reviewing a more formal and detailed description of some of the embodiments of the invention below.

### BRIEF DESCRIPTION OF THE DRAWINGS

Efforts have been made to maintain consistency of numbered elements among the figures. However, to preserve readability, not each element present in each figure is labeled. Nonetheless, when this application and its incorporated references are considered as a whole, the meaning or importance of any unlabeled elements in any particular figure will become apparent to a person of ordinary skill.

FIG. 1 depicts properties of an equilateral triangle.

FIG. 2 depicts difference between various embodiments depending on their treatment of home vertices when a point of interest coincides with an edge or vertex of a cell.

FIG. 3 depicts one embodiment pertaining to a point of interest p with its home cell on a plane or surface of interest modeled using cells that are equilateral triangles.

FIG. 4 depicts one embodiment pertaining to a point of interest p with its home cells in a space of interest modeled using cells that are cubes.

FIG. 5 depicts various planetary solids, including an icosahedron, a dodecahedron, a truncated icosahedron, and pentakis dodecahedron as a flattened set of contiguous triangles.

FIG. 6 depicts a surface of interest modeled as faces of an icosahedron with a point of interest p associated with one of its faces ΔUVW, and a ray projected from the center of the icosahedron through p and the containing face.

FIG. 7 depicts one embodiment pertaining to a surface of interest and a point of interest similar to that depicted in FIG. 6, but where the face ΔUVW has been subdivided using quantized barycentric triangulation to find p's home cell and home vertices.

FIG. 8 depicts one embodiment pertaining to a close-up of the subdivision of ΔUVW using depicted in FIG. 7.

FIG. 9 depicts one embodiment pertaining to a point of interest p with its home cell on a surface of interest modeled using cells that are regular hexagons.

FIG. 10 depicts a block diagram of one embodiment pertaining to components that may be present in devices and computer systems that implement aspects of the invention.

FIG. 11 depicts a block diagram of one embodiment of the invention pertaining to storage of point records and associated data in a data store.

FIG. 12 depicts a flowchart of one embodiment pertaining to a process to retrieve point records or associated data from a data store that match arbitrary criteria.

FIG. 13 depicts a block diagram of one embodiment of the invention pertaining to a context of a computer network.

FIG. 14 depicts a flowchart of one embodiment pertaining to a process to store new point records and associated data in a data store.

FIG. 15 depicts one embodiment pertaining to a point of interest p with its home cells in a space of interest modeled using cells that are cubes.

FIG. 16 depicts an “altitude” conceptualization of a single component of a barycentric coordinate for a two-dimensional triangle.

FIG. 17 depicts barycentric subdivisions of 4 and 8 for a two-dimensional triangle.

FIG. 18 depicts an arbitrary subdivision of a two-dimensional triangle using quantized barycentric triangulation of a point of interest p for one embodiment.

FIG. 19 depicts visualization of one embodiment in which Cubic Quantization is used to model points of interest on the surface of the Earth.

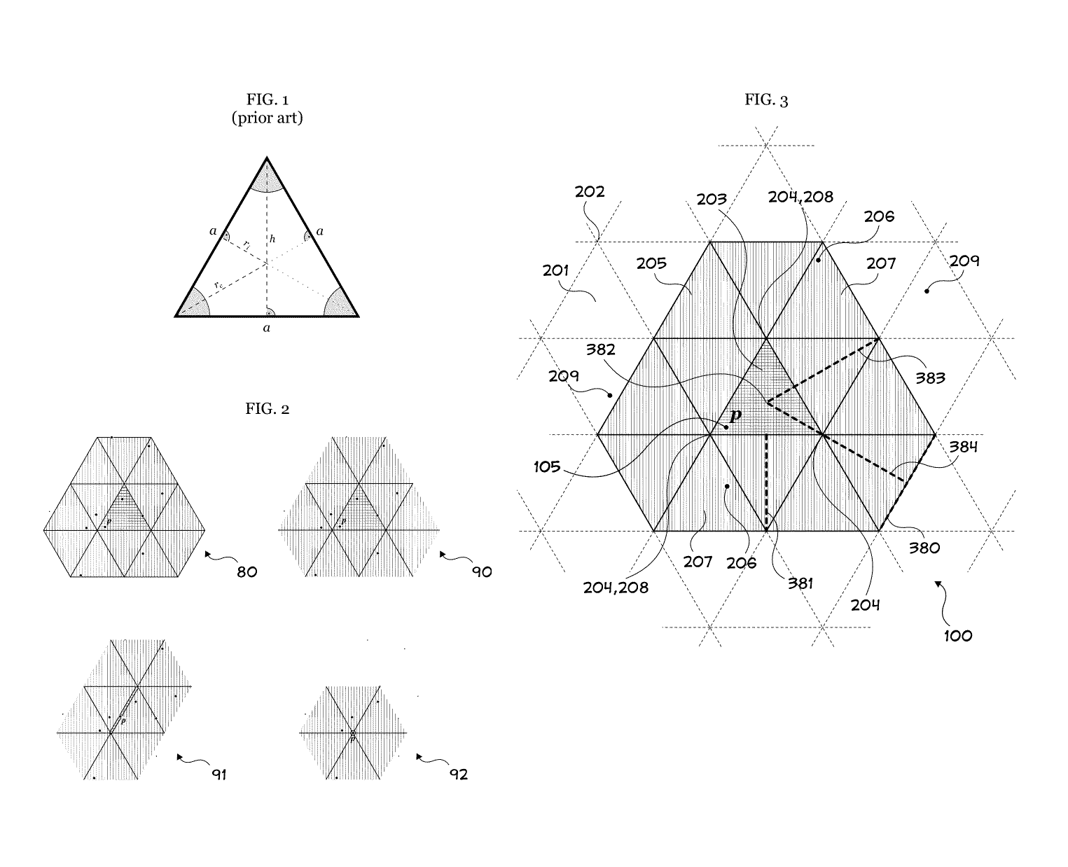

### DESCRIPTION OF THE EMBODIMENTS

The following describes preferred embodiments. However, the invention is not limited to those embodiments. The description that follows is for purpose of illustration and not limitation. Other systems, methods, features and advantages will be or will become apparent to one skilled in the art upon examination of the figures and detailed description. It is intended that all such additional systems, methods, features, and advantages be included within this description, be within the scope of the inventive subject matter, and be protected by the accompanying claims.

A space of interest 100 is divided into contiguous shapes called “cells” or “quanta” 201 (i.e., such that no gaps exist between any cells). Each cell 201 has two or more vertices 202. Each cell 201 shares at least one vertex 202 with at least one other cell 201, but the set of each cell's vertices 202 is unique to that cell 201. For a point of interest p 105 in the space of interest 100, there exists at least one home cell 203 which contains p. In a vast majority of cases, for a given division of the space of interest 100, each point of interest 105 is enclosed by exactly one cell, so it is customary to refer to the singular “home cell”. However, it is possible that a point of interest 105 coincides with more than one cell (e.g., if it coincides with a face, edge, or vertex 202, or if two or more divisions are applied simultaneously to the space of interest 100). Vertices of p's home cell are referred to as p's “home vertices” 204, or a “set of [p's] home vertices”.

The point of interest p 105 is considered “near” a second point of interest q 206 when the home cell 203 of p shares at least one vertex 208 with the home cell 207 of q. Points 209 which do not share at least one home vertex with the point of interest 105 are not considered “near”. More formally, the invention defines two points p and q as being “near” each other if and only if p and q share at least one home vertex. (See Eq. 4.)

Equation 4: a near point

near (\vec{p},\vec{q}) [symbol] home(\vec{p})∩home(\vec{q})≠0

A common scenario asks, given a single point of interest p 105 and a set of points of significance Q, what is the subset Q′ which is near to p? (See Eq. 5.)

Equation 5: subset of near points

Q′=[\vec{q}:\vec{q}εQ, near(\vec{p},\vec{q})]

More than one set of home vertices 204 may be associated with each point of interest 105. For example, assuming radii of 1, 10, and 100 km are known in advance to be of interest, one could associate each point of interest 105 with three distinct sets of home vertices 204, each set corresponding to a single radius (i.e., one for 1 km, one for 10 km, and one for 100 km). If the associations were stored in a data store as discussed below, queries specific to one radius would be made against the appropriate set of home vertices 204.

Much discussion herein is directed toward the use of vertices as the mechanism by which “nearness” is identified. However, the invention is not limited to vertices. Alternate embodiments could use edges, faces, n-faces, etc., to capture the interfaces (n-borders) between cells 201. In those embodiments, one computes “home edges”, “home faces”, etc., instead of or in addition to home vertices 204 for each point of interest 105). Equation 6 depicts aspects of one embodiment that uses an “average” point to identify an n-border, where m is the number of vertices defining the n-border, and n is the number of dimensions in the space of interest 100. If the n-border is an edge, m is two. If the n-border is a face, m is at least three. As will be described in more detail below, If the n-border is an n-face in the case of N-Quantization, m is 2ⁿ.

$$identifying an n \text{-} border B by {its }^{″} {average}^{″} point {b}_{avg} \\ B = [ {\vec{v}}_{1} , … , {\vec{v}}_{m} ] \\ B = \{ [ \begin{matrix}{v}_{{1}_{1}} \\ ⋮ \\ {v}_{{1}_{n}}\end{matrix} ] , … , [ \begin{matrix}{v}_{{m}_{1}} \\ ⋮ \\ {v}_{{m}_{n}}\end{matrix} ] \} \\ \vec{{b}_{avg}} = [ \begin{matrix}avg ( {v}_{{1}_{1}} , … , {v}_{{m}_{1}} ) \\ ⋮ \\ avg ( {v}_{{1}_{n}} , … , {v}_{{m}_{n}} )\end{matrix} ] \qquad Equation 6$$

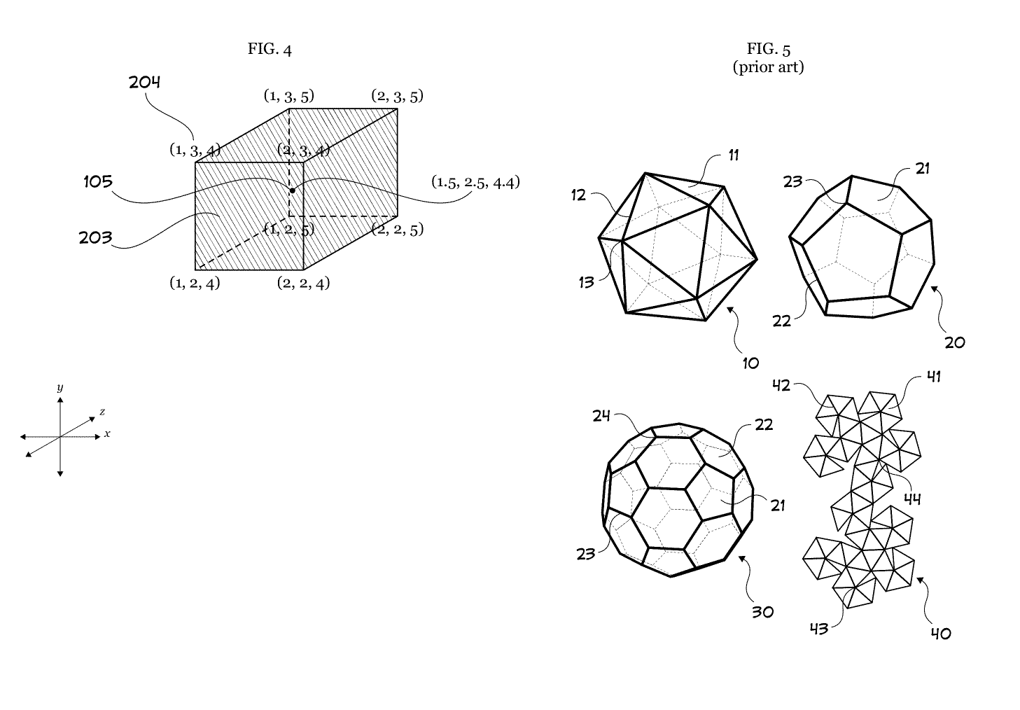

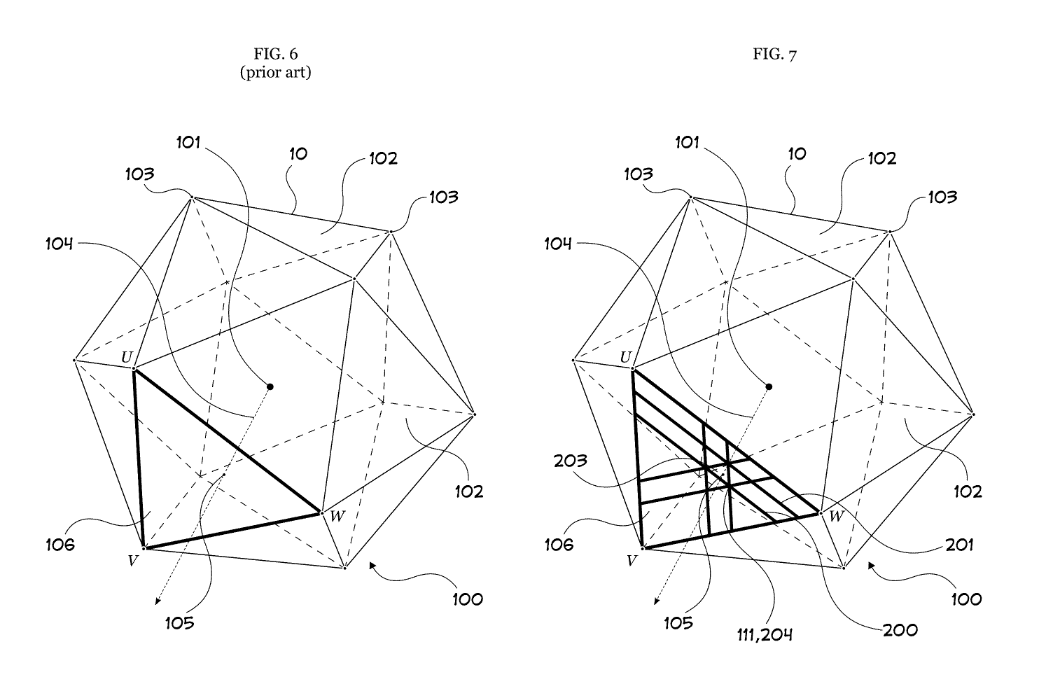

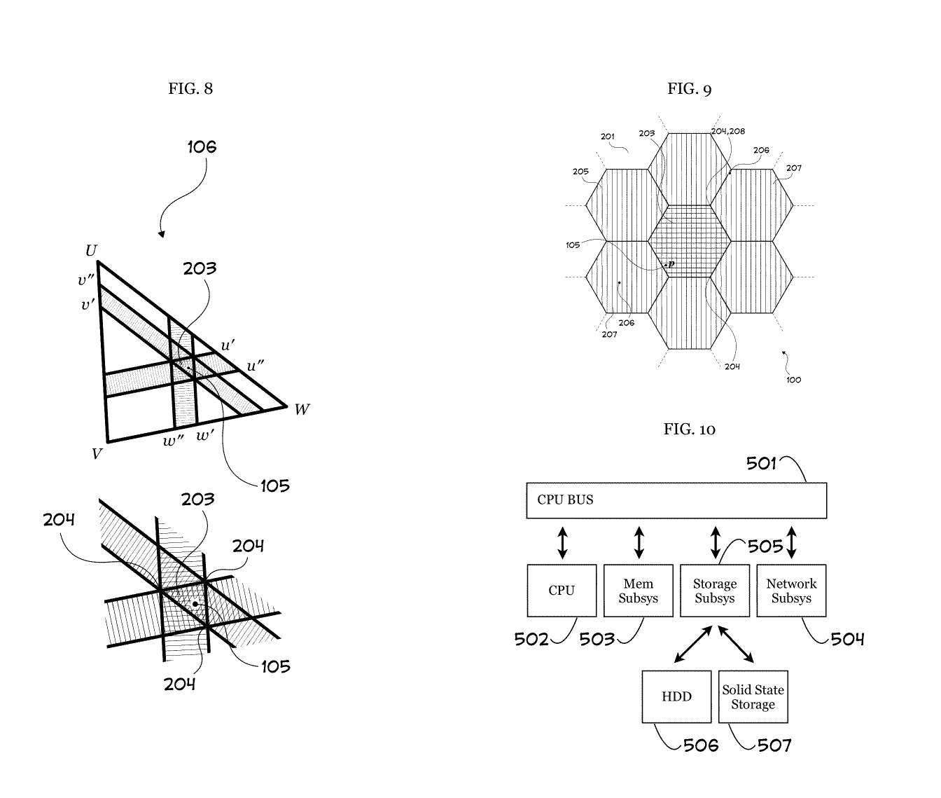

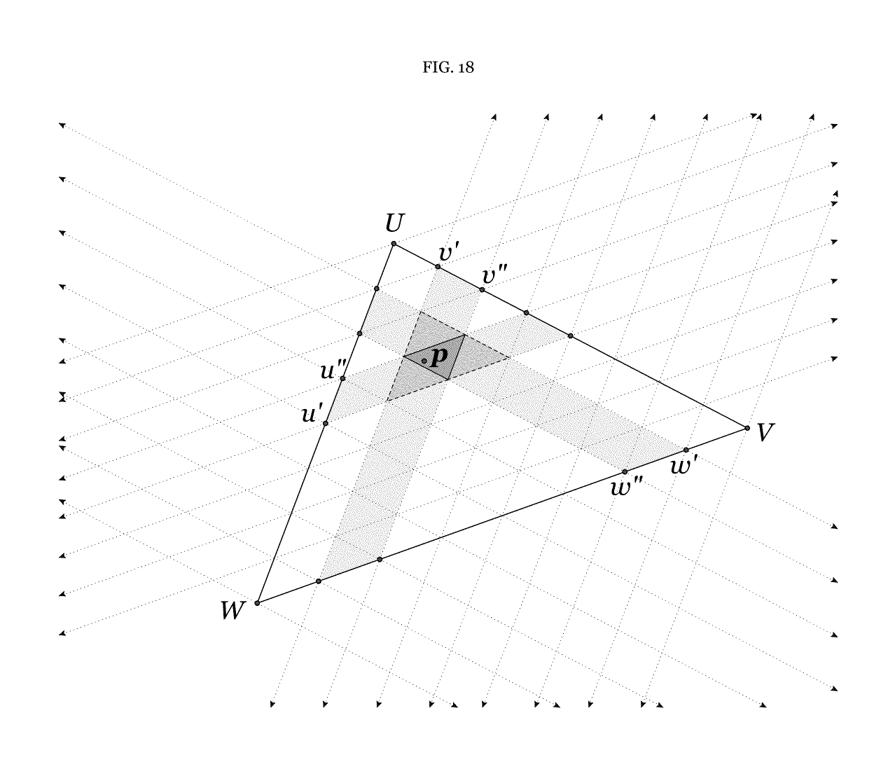

It is also worth noting that the terms “vertex” and “vertices” in this context are used similarly to “nodes” in computer modeling, namely that they often, but do not necessarily imply sharp corners or straight edges. Although computationally more expensive, as non-limiting examples, vertices could be a nodes on a Bézier curve or non-uniform rational basis b-spline (NURBS). More commonly, however, they define triangles (as depicted in FIGS. 2, 3, 7, 8, 14, and 18), squares or other quadrilaterals, hexagons (as depicted in FIG. 9), tetrahedrons, cubes (as depicted in FIGS. 4 and 15) or other quadrilaterally-faced hexahedra, combinations thereof, etc.

### Approximating Nearness on a Plane or Surface

In one embodiment, a surface of interest 100 is modeled using roughly equal-sized cells 201 distributed over that surface of interest 100 such that the surface of interest 100 is entirely covered with cells 201 without any gaps. See generally FIGS. 3, 5, and 9. A point of interest 105 (often labeled p in the figures) is identified and described using a coordinate system. A translation between the point of interest p's 105 coordinates and the coordinates of the cells 201 is performed if necessary. p's home cell 203 is identified. This may be a direct determination where each point of interest 105 is guaranteed to coincide with the plane of its home cell 203, in which case p's home cell 203 is that which contains p. However, in other cases, p may need to be “projected” onto the surface of interest 100.

As a non-limiting example, p references a point on Earth, and is likely described using two of three components of spherical coordinates (i.e., latitude/longitude without a distance from a center). Assume the surface of interest 100 is a “bird's eye” view of the Earth (i.e., without concern for altitude) modeled by an icosahedron 10 described in cartesian coordinates, whose faces have been subdivided as necessary to achieve a desired cell size. After p's known coordinate components are translated (e.g., using an arbitrary, nonzero value for the distance from the center), a ray 104 is projected from a reference point 101 (i.e., the center of the icosahedron) through the point of interest p 105. The cell 201 intersected by the ray 104 is p's home cell 203.

Continuing with the example, say the desired radii of interest were 1 km, 10 km, and 100 km. Assuming a mean radius for Earth of 6,371 km, set the radius for each vertex 103 of the model icosahedron 10 to 6,371 km. The length of each edge for each face 102 of the icosahedron 10 is defined by Eq. 7.

$$( prior art ) the edge length a , height h , and arc lengths {l}_{a} and {l}_{h} , of an icosahedron given its vertex radius \\ \frac{a}{4} \sqrt{10 + 2 \sqrt{5}} = {r}_{v} \\ \frac{a}{4} \sqrt{10 + 2 \sqrt{5}} = 6 , 371 \\ a \approx 6 , 699 \\ h = \frac{\sqrt{3}}{2} a \\ h \approx 5 , 801 \\ {l}_{a} \approx 7 , 054 \\ {l}_{h} \approx 6 , 109 \qquad Equation 7$$

In order for the cells 201 to accommodate the radii of interest, and assuming that any radius of interest is properly approximated in the example by twice the height of any particular cell 201, each face 102 of the icosahedron 10 is subdivided 3,054, 305, and 30 times to accommodate radii of interest of 1 km, 10 km, and 100 km, respectively. In one embodiment subdivisions are determined or approximated recursively (see U.S. 61/313,733 to which this application claims priority).

### Surface Subspecies: Quantized Barycentric Triangulation

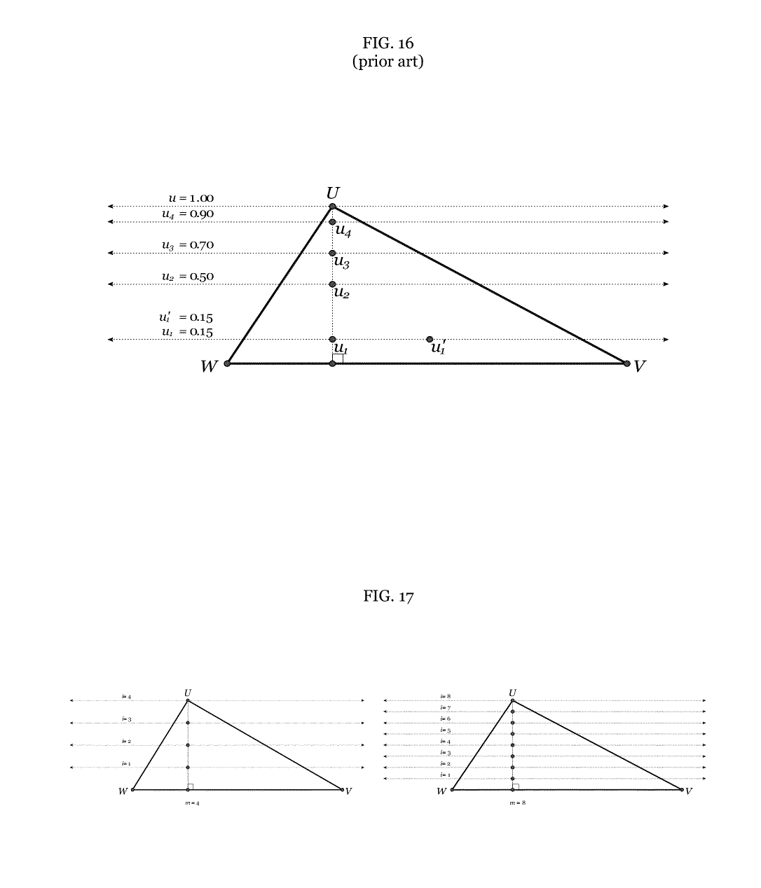

While not often described this way, a triangular barycentric coordinate for a given vertex may be thought of as a normalized “altitude” above that vertex's opposing edge where 0% describes a line colinear with the opposing edge, and 100% describes a line parallel to the opposing edge which intersects the vertex. (See FIG. 16.)

Conversion from cartesian coordinates to barycentric coordinates (and back again) is known in the art. (See Eqs. 8 and 9, and Code List. 2.) As are algorithms that determine a ray's point of intersection in terms of barycentric coordinates.⁸ (See Code List. 3.) ⁸ Möller, T., & Trumbore, B. (1997). Fast, minimum storage ray-triangle intersection. Journal of Graphics Tools, 2(1), 21-28.

$$\begin{matrix}( prior art ) conversion of barycentric coordinates u , v , and w and a triangle Δ UVW to a point p \\ Δ UVW = \{ [ \begin{matrix}{x}_{u} \\ {y}_{u}\end{matrix} ] , [ \begin{matrix}{x}_{v} \\ {y}_{v}\end{matrix} ] , [ \begin{matrix}{x}_{w} \\ {y}_{w}\end{matrix} ] \} \\ {x}_{p} = {ux}_{u} + {vx}_{v} + {wx}_{w} \\ {y}_{p} = {uy}_{u} + {vy}_{v} + {wy}_{w} \\ \vec{p} = [ \begin{matrix}{x}_{p} \\ {y}_{p}\end{matrix} ] & Equation 8 \\ ( prior art ) conversion of a point p in a triangle Δ UVW from two \text{-} dimensional cartesian coordinates to barycentric coordinates u , v , and w \\ u = \frac{( {y}_{v} - {y}_{w} ) ( {x}_{p} - {x}_{w} ) + ( {x}_{w} - {x}_{v} ) ( {y}_{p} - {y}_{w} )}{( {y}_{v} - {y}_{w} ) ( {x}_{u} - {x}_{w} ) + ( {x}_{w} - {x}_{v} ) ( {y}_{u} - {y}_{w} )} \\ v = \frac{( {y}_{w} - {y}_{u} ) ( {x}_{p} - {x}_{w} ) + ( {x}_{u} - {x}_{w} ) ( {y}_{p} - {y}_{w} )}{( {y}_{v} - {y}_{w} ) ( {x}_{u} - {x}_{w} ) + ( {x}_{w} - {x}_{v} ) ( {y}_{u} - {y}_{w} )} \\ w = 1 - u - v & Equation 9\end{matrix}$$

Code Listing 2: Pythonic pseudocode for converting a
barycentric coordinate in a triangle in 3-space to a
cartesian vector in 3-space

```
def bc2Cart(a_UVW, a_u, a_v, a_w = None):
    # Takes a triangle a_UVW as a set of three point vectors and
    # a barycentric coordinate as a_u, a_v, a_w, and returns the
    # corresponding cartesian coordinate; adapted from
    # <http://en.wikipedia.org/wiki/
    # Barycentric coordinates %28mathematics%29>
    if a_w is None:
        w = 1 − a_u − a_v
    else:
        w = a_w
    bc_coords = ( w, a_u, a_v )
    x = sum(i * j for i, j in zip((a_UVW[i][0] for i in \
        range(len(a_UVW))), bc_coords))
    y = sum(i * j for i, j in zip((a_UVW[i][1] for i in \
        range(len(a_UVW))), bc_coords))
    z = sum(i * j for i, j in zip((a_UVW[i][2] for i in \
        range(len(a_UVW))), bc_coords))
    return ( x, y, z )
```

Code Listing 3: Pythonic pseudocode for performing Möller's
and Trumbore's barycentric intersection algorithm in 3-space

```
from _future_{—} import division
import math
# Specialized vector subtraction for 3-component vectors
vecsub = lambda a_p vec, a_q_vec: ( \
    a_p_vec[0] − a_q_vec[0], \
    a_p_vec[1] − a_q_vec[1], \
    a_p_vec[2] − a_q_vec[2] )
# Specialized cross product for 3-component vectors
veccross = lambda a_p_vec, a_q_vec: ( \
    a_p_vec[1] * a_q_vec[2] − a_p_vec[2] * a_q_vec[1], \
    a_p_vec[2] * a_q_vec[0] − a_p_vec[0] * a_q_vec[2], \
    a_p_vec[0] * a_q_vec[1] − a_p_vec[1] * a_q_vec[0] )
# Specialized dot product for 3-component vectors
vecdot = lambda a_p_vec, a_q_vec: \
    a_p_vec[0] * a_q_vec[0] + \
    a_p_vec[1] * a_q_vec[1] + \
    a_p_vec[2] * a_q_vec[2]
def normalize(a_p_vec):
    scale = math.sqrt(vecdot(a_p_vec, a_p_vec))
    return ( \
        a_p_vec[0] / scale, \
        a_p_vec[1] / scale, \
        a_p_vec[2] / scale )
ORIGIN_VEC = ( 0, 0, 0 )
def mtBarycentricIntersection(a_p, a_UVW):
    # Returns ( u, v, w ) if the point a_p intersects triangle
    # a_UVW and None if it doesn't; adapted from
    # <http://www.graphics.cornell.edu/pubs/1997/MT97.html>
    p_norm = normalize(a_p)
    edge01_vec = vecsub(a_UVW[1], a_UVW[0])
    edge02_vec = vecsub(a_UVW[2], a_UVW[0])
    p_vec = veccross(p_norm, edge02_vec)
    det = vecdot(edge01_vec, p_vec)
    if det == 0:
        return None
    inv_det = 1 / det
    t_vec = vecsub(ORIGIN_VEC, a_UVW[0])
    q_vec = veccross(t_vec, edge01_vec)
    t = vecdot(edge02_vec, q_vec) * inv_det
    u = vecdot(t_vec, p_vec) * inv_det
    v = vecdot(p_norm, q_vec) * inv_det
    w = 1 − u − v
    if t < 0 \
            or u < 0 \
            or v < 0 \
            or w < 0:
        return None
    return ( u, v, w )
```

In another embodiment, subdivision of faces which are triangles is performed using Quantized Barycentric Triangulation as follows. (See FIGS. 7, 8, 17, and 18.) Identify the face to be subdivided. In continuing the example above, this is the intersected face ΔUVW 106 of the icosahedron 10 used to model the Earth. Determine the barycentric coordinates [u, v, w] for the intersection of the point of interest p 105 (or p's projection) with ΔUVW. From u, v, and w, and a number of subdivisions m, compute u′, u″, v′, v″, w′, and w″, such that:

$${u}^{′} = \frac{{i}^{′}}{m} {v}^{′} = \frac{{j}^{′}}{m} {w}^{′} = \frac{{k}^{′}}{m}$$

$${u}^{″} = \frac{{i}^{″}}{m} {v}^{″} = \frac{{j}^{″}}{m} {w}^{″} = \frac{{k}^{″}}{m}$$

Where i′, i″, j′, j″, k′, and k″ satisfy the following conditions:

$${i}^{′} = \{ max ( [ 0 , m ] ) : {i}^{′} ∈ {ℕ}_{0} , \frac{{i}^{′}}{m} \leq u \}$$

$${i}^{″} = \{ min ( [ 0 , m ] ) : {i}^{″} ∈ {ℕ}_{0} , \frac{{i}^{″}}{m} \geq u \}$$

$${j}^{′} = \{ max ( [ 0 , m ] ) : {j}^{′} ∈ {ℕ}_{0} , \frac{{j}^{′}}{m} \leq v \}$$

$${j}^{″} = \{ min ( [ 0 , m ] ) : {j}^{″} ∈ {ℕ}_{0} , \frac{{j}^{″}}{m} \geq v \}$$

$${k}^{′} = \{ max ( [ 0 , m ] ) : {k}^{′} ∈ {ℕ}_{0} , \frac{{k}^{′}}{m} \leq w \}$$

$${k}^{″} = \{ min ( [ 0 , m ] ) : {k}^{″} ∈ {ℕ}_{0} , \frac{{k}^{″}}{m} \geq w \}$$

In English, each of i′, i″, j′, j″, k′, and k″ is an integer greater than or equal to zero. i′ is the maximum value in the range [0, m] such that the ratio of i′ to m is less than or equal to the u component of barycentric coordinate for the intersection point for p in ΔUVW. i″ is the minimum value in the range [0, m] such that the ratio of i″ to m is greater than or equal to the u component of barycentric coordinate for the intersection point for p in ΔUVW. And so on . . . .

After computing u′, u″, v′, v″, w′, and w″, determine which of {[u″, v′, w′], [u′, v″, w′], [u′, v′, w″], [u″, v″, w′], [u″, v′, w″], [u′, v″, w″]} define valid barycentric coordinates in ΔUVW. This is easily done, since the sum of all components of a barycentric coordinate must be equal to 1. Those which are valid define the vertices 204 of the subdivision 203. If necessary, they can be converted back into the model (e.g., cartesian) coordinates.

Typically, there are three valid barycentric coordinates from the set above. However, it is rare but possible (if the intersection point for p falls on an edge or vertex of a subdivision) that only two are or one is valid, defining a line segment or point, respectively. In another embodiment, where it is advantageous that the intersection point for p always be found in a subdivision that is a triangle, the following additional limitations can be imposed:

$${i}^{″} = \{ min ( [ 1 , m ] ) : {i}^{″} ∈ {ℕ}_{1} , \frac{{i}^{″}}{m} > u \}$$

$${j}^{″} = \{ min ( [ 1 , m ] ) : {i}^{″} ∈ {ℕ}_{1} , \frac{{j}^{″}}{m} > v \}$$

$${k}^{″} = \{ min ( [ 1 , m ] ) : {k}^{″} ∈ {ℕ}_{1} , \frac{{k}^{″}}{m} > w \}$$

$$or$$

$${i}^{′} = \{ max ( [ 0 , m ] ) : {i}^{′} ∈ {ℕ}_{0} , \frac{{i}^{′}}{m} < u \}$$

$${j}^{′} = \{ max ( [ 0 , m ] ) : {j}^{′} ∈ {ℕ}_{0} , \frac{{j}^{′}}{m} < v \}$$

$${k}^{′} = \{ max ( [ 0 , m ] ) : {k}^{′} ∈ {ℕ}_{0} , \frac{{k}^{′}}{m} < w \}$$

In English, each of i″, j″, and k″ is an integer greater than or equal to one (not zero). i″ is the minimum value in the range [0, m] such that the ratio of i″ to m is greater than (not greater than or equal) to the u component of barycentric coordinate for the intersection point for p in ΔUVW. Similar differences would apply with respect to j″ with respect to v and k″ with respect to w. Alternatively, each of i′, j′, and k′ is an integer greater than or equal to zero. i′ is the minimum value in the range [0, m) (not [0, m]) such that the ratio of i′ to m is less than (not less than or equal) to the u component of barycentric coordinate for the intersection point for p in ΔUVW. And so on . . . .

In another embodiment, an optimization can be made. Rather than enumerate each of {[u″, v′, w′], [u′, v″, w′], [u′, v′, w″], [u″, v″, w′], [u″, v′, w″], [u′, v″, w″]} and then determine which of them are valid barycentric coordinates, one can calculate the sum of i″, j″, and k″. Where the sum is odd, none of {[u″, v″, w′], [u″, v′, w″], [u′, v″, w″]} results in valid barycentric coordinates, and are ignored. Where the sum is even, none of {[u″, v′, w′], [u′, v″, w′], [u′, v′, w″]} results in valid barycentric coordinates, and are ignored.

Code Listing 4 describes Pythonic pseudocode for some of the aforementioned embodiments and examples. Some “subroutines” are defined in other code listings.

Code Listing 4: Pythonic pseudocode for modeling Earth as a
surface of interest using an icosahedron, and using quantized
barycentric triangulation to perform subdivisions to identify
home vertices for a point of interest for 3,054, 305, and 30
subdivisions

```
from _future_ import division
import math
# Adapted from <http://www.neubert.net/Htmapp/SPHEmesh.htm>
class Icosahedron:
  ZERO = 0
  ONE = 1
  TAU = 1.618033988749895 # Golden ratio
  # We don't really care about the scale, since we're
  # normalizing everything anyway; the important thing is that
  # we maintain a single scale for our model surface; the only
  # time this won't work is if we reach the machine's floating
  # point limits because of a scale/model mismatch (i.e., where
  # one is huge and the other is tiny); in that case, we can
  # adapt the model accordingly, use a symbolic math package
  # like sympy, etc.
  VERTICES = (
    (
      ( TAU, ONE, ZERO ) ,
      ( −TAU, ONE, ZERO ) ,
      ( −TAU, −ONE, ZERO ) ,
      ( TAU, −ONE, ZERO ) ,
    ) , (
      ( ONE, ZERO, TAU ),
      ( ONE, ZERO, −TAU ),
      ( −ONE, ZERO, −TAU ),
      ( −ONE, ZERO, TAU ),
    ) , (
      ( ZERO, TAU, ONE ),
      ( ZERO, −TAU, ONE ),
      ( ZERO, −TAU, −ONE ),
      ( ZERO, TAU, −ONE ),
    )
  )
  FACES = (
    ( VERTICES[1][0], VERTICES[2][0], VERTICES[1][3] ),
    ( VERTICES[1][0], VERTICES[1][3], VERTICES[2][1] ),
    ( VERTICES[1][1], VERTICES[1][2], VERTICES[2][3] ),
    ( VERTICES[1][1], VERTICES[2][2], VERTICES[1][2] ),
    ( VERTICES[0][0], VERTICES[1][0], VERTICES[0][3] ),
    ( VERTICES[0][0], VERTICES[0][3], VERTICES[1][1] ),
    ( VERTICES[0][2], VERTICES[1][3], VERTICES[0][1] ),
    ( VERTICES[0][2], VERTICES[0][1], VERTICES[1][2] ),
    ( VERTICES[2][0], VERTICES[0][0], VERTICES[2][3] ),
    ( VERTICES[2][0], VERTICES[2][3], VERTICES[0][1] ),
    ( VERTICES[2][1], VERTICES[2][2], VERTICES[0][3] ),
    ( VERTICES[2][1], VERTICES[0][2], VERTICES[2][2] ),
    ( VERTICES[2][0], VERTICES[1][0], VERTICES[0][0] ),
    ( VERTICES[2][3], VERTICES[0][0], VERTICES[1][1] ),
    ( VERTICES[1][0], VERTICES[2][1], VERTICES[0][3] ),
    ( VERTICES[1][1], VERTICES[0][3], VERTICES[2][2] ),
    ( VERTICES[1][3], VERTICES[2][0], VERTICES[0][1] ),
    ( VERTICES[1][2], VERTICES[0][1], VERTICES[2][3] ),
    ( VERTICES[1][3], VERTICES[0][2], VERTICES[2][1] ),
    ( VERTICES[1][2], VERTICES[2][2], VERTICES[0][2] ),
  )
  del ZERO, ONE, TAU, VERTICES
  EDGE_LEN = vecsub(FACES[0][1], FACES[0][0])
  EDGE_LEN = math.sqrt(vecdot(EDGE_LEN, EDGE_LEN))
  RADIUS_U = EDGE_LEN / 4 * math.sqrt(10 + 2 * math.sqrt(5))
  RADIUS_M = EDGE_LEN / 4 * (1 + math.sqrt(5))
  RADIUS_I = EDGE_LEN * \
    math.sqrt(3) / 12 * (3 + math.sqrt(5))
def quantize(a_v, a_m):
  ″″″
  >>> quantize(0, 1)
  [0, 1]
  >>> quantize(−10, 1)
  [−10, −9]
  >>> quantize(0.25, 1 / 2)
  [0.0, 0.5]
  >>> quantize(105, 50)
  [100, 150]
  >>> quantize(−105, 50)
  [−150, −100]
  ″″″
  quantized = a_v // a_m
  if a_v < 0:
    return [ (quantized − 1) * a_m, quantized * a_m ]
  # a_v >= 0
  return [ quantized * a_m, (quantized + 1) * a_m ]
def intersect(a_p, a_model_faces, a_subdivisions_of_interest):
  home_vertices = { }
  for subdv in a_subdivisions_of_interest:
    home_vertices[subdv] = set( )
  for face in a_model_faces:
    bc_coords = mtBarycentricIntersection(a_p, face)
    if bc_coords is not None:
      break
  if bc_coords is not None:
    u, v, w = bc_coords
    for subdv in a_subdivisions_of_interest:
      uq = quantize(u, 1 / subdv)
      vq = quantize(v, 1 / subdv)
      wq = quantize(w, 1 / subdv)
      # Narrow based on parity
      if sum(uq[1], vq[1], wq[1]) % 2 == 0:
        candidates = (
          ( uq[1], vq[1], wq[0] ) ,
          ( uq[1], vq[0], wq[1] ) ,
          ( uq[0], vq[1], wq[1] ) ,
        )
      else:
        candidates = (
          ( uq[1], vq[0], wq[0] ) ,
          ( uq[0], vq[1], wq[0] ) ,
          ( uq[0], vq[0], wq[1] ) ,
        )
      # Technically, because quantize( ) always results in a
      # pair of numbers, and because we're narrowing based
      # on parity, this step is unnecessary; all
      # coordinates in candidates *should* be valid
      valid_uvw = \
        [ uvw for uvw in candidates if sum(uvw) == 1 ]
      for uvw in valid_uvw:
        home_vertices[subdv]. \
          add(bc2Cart(face, uvw))
  return home_vertices
GPS_COORD = ( ..., ..., Icosahedron.RADIUS_U ) # lat/lon
print intersect(sphere2Cart(*GPS_COORD), \
  Icosahedron.FACES, ( 3054, 305, 30 ))
```

### Approximating Nearness in an N-Dimensional “Volume” Using Cubic Quantization and N-Quantization

Generally, “volumetric” N-Quantization (of which Cubic Quantization is a specialized type) refers to computing a home quantum Sₚ 203 given an arbitrary point of interest p 105 in n-space, loosely comprising: selecting an origin for a cartesian coordinate system to model a space of interest 100 comprising n-dimensions; subdividing the space of interest 100 into quanta S₁ . . . Sₘ 201 (where m is a natural number greater than 1), each of whose vertices 202 are defined by 2ⁿ point pairs; finding the home vertices of Sₚ 204 by quantizing or rounding p's components [p₁, . . . ,pₙ] to their nearest subdivision pairs, [p₁′,p₁″], . . . , [pₙ′,pₙ″] and computing the 2ⁿ home vertices 204 as the n-ary Cartesian product of the subdivision pairs.

### Volume Subspecies: Cubic Quantization

The specific approach where cubes or n-cubes are used as quanta 201 to model the space of interest 100 is referred to as “Cubic Quantization” (as in the above example). Cubic Quantization is a specialized application of a more general approach called “N-Quantization”, which is described below.

To illustrate by way of a simple example, say n is 3, the point of interest p 105 is defined by the cartesian coordinates [1.5, 2.5, 4.4], and the quanta S₀ . . . Sₘ 201 are cubes with edges of length 1 whose vertices 202 are integers (i.e., the space of interest 100 is subdivided into unit cube quanta). p_{d} is a component in dimension d (or d-component) of p. p_{d}′ is a boundary in dimension d (or d-boundary), which is computed in this case by rounding p_{d} down to the nearest integer. p_{d}″ is a second d-boundary, which is computed in this case by rounding p_{d} up to the nearest integer.⁹ Sₚ is a home cube 203 described by the home vertices 204: {[p₁′,p₂′,p₃′], [p₁″,p₂′,p₃′], [p₁′,p₂″,p₃′], [p₁′,p₂′,p₃″],p₁″, [p₂″,p₃′], [p₁″,p₂′,p₃″], [p₁′,p₂″,p₃″], [p₁″, p₂″,p₃″]} or {[1,2,4], [2,2,4], [1,3,4], [1,2,5], [2,3,4], [2,2,5], [3,5], [2,3,5]}. (See FIG. 4.) ⁹ Many software libraries define functions, often called floor and ceil, to perform these rounding calculations. See, e.g., <math.h> in C standard library, the math module in the standard Python library, and the Math standard object in JavaScript, to name a few.

In the above example, where p_{d} falls exactly on an integer, redundant boundaries are generated as p_{d}′ and p_{d}″ are the same value. A more thorough treatment of such situations is described in another section below, but briefly, if redundancies are undesirable, they can be discarded, or p_{d}′ and p_{d}″ can be redefined accordingly. (See, e.g., Eq. 10.)

Equation 10: two example embodiments redefining p_{d}′ and p_{d}″ to avoid redundancies where a space of interest is divided into unit cubes whose vertices' components are integers

p_{d}′=floor(p_{d})

p_{d}″=p_{d}′+1

or

p_{d}′=p_{d}″−1

p_{d}″=ceil(p_{d})

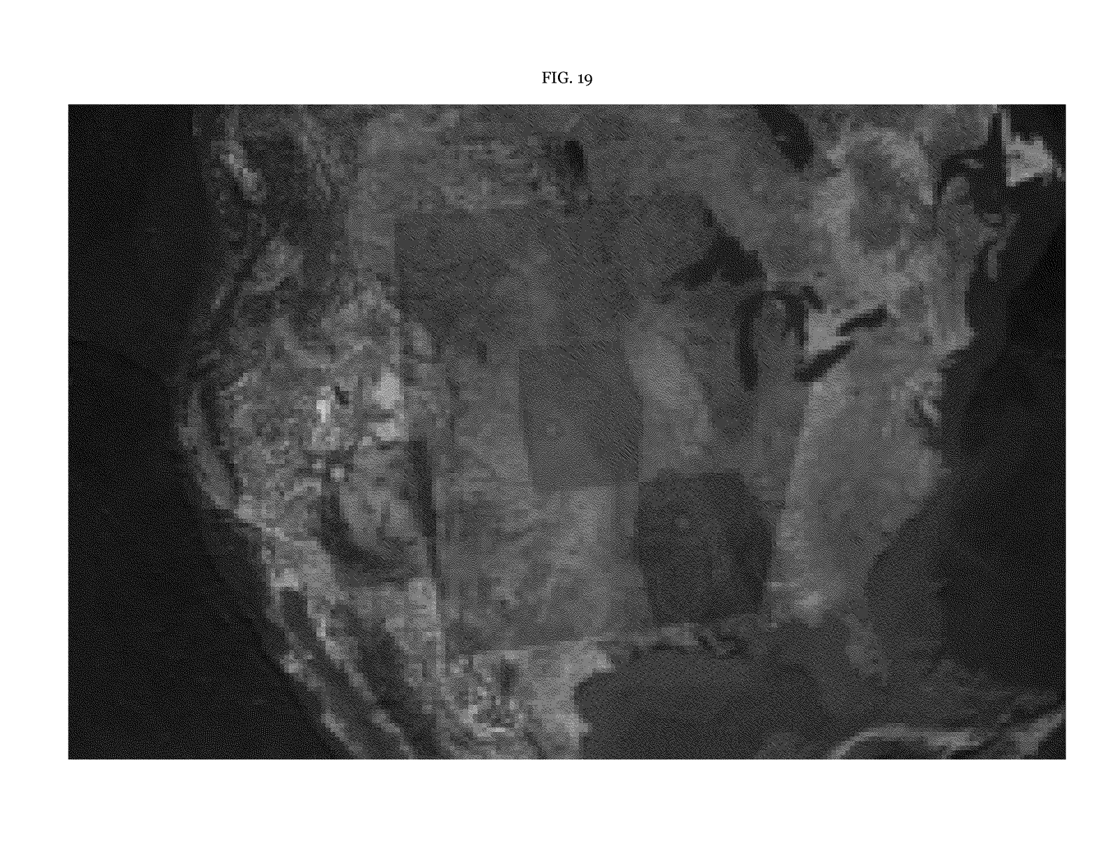

FIG. 19 depicts visualization of one embodiment in which Cubic Quantization is used to model points of interest on the surface of the Earth. In the depicted embodiment, the origin is at the Earth's center and the edge length of the cubic home quanta is approximately 1,000 km. The green dot is the point of interest 105, the green cube is its home quantum 203, the red dots and cubes are other points of significance and their respective home quanta, and the large gray cube contains points near to the point of interest 105.

### Volume Subspecies: N-Quantization

Where Cubic Quantization divides the space of interest 100 into cubes, N-Quantization divides the space of interest 100 into rectangular cuboids (of which cubes are a specialized subset). For each dimension d in an n-dimensional space of interest 100, subdivide d by applying a mapping function ƒ_{d}(x). The subdivisions in dimension d (or d-subdivisions) need not be uniform (i.e., ƒ_{d}(x) need not be linear). The relationship of a d-subdivision x to its boundary in dimension d (or d-boundary) is the mapping function ƒ_{d}(x). The inverse relationship of a d-boundary to its d-subdivision is the inverse mapping function ƒ_{d}⁻¹(x). In other words, the relationship ƒ_{d}(x) “maps” a d-subdivision to its d-boundary, and the inverse relationship fa⁻¹(x) maps a d-boundary to its d-subdivision.

These mapping functions allow the quantization of a component in dimension d (or d-component) p_{d} for a point of interest p 105. In general, to determine the d-boundaries p_{d}′ and p_{d}″ of the d-component p_{d} for p's home quantum 203, apply the inverse mapping function ƒ_{d}⁻¹(x) to p_{d}, then quantize the result to the nearest two values x_{d}′ and x_{d}″ in the domain of the mapping function ƒ_{d}(x), and finally, apply the mapping function ƒ_{d}(x) to x_{d}′ and x_{d}″ to get p_{d}′ and p_{d}″:

x_{d}′={max(x):xεdom(ƒ_{d}),x≦ƒ_{d}⁻¹(p_{d})}

x_{d}″={min(x):xεdom(ƒ_{d}), x≧ƒ_{d}⁻¹(p_{d})}

p_{d}′=ƒ_{d}(x_{d}′)

p_{d}″=ƒ_{d}(x_{d}″)

In alternate embodiments (explored more generally in another section below), one bound or the other can be exclusive instead of inclusive:

x_{d}′={max(x):xεdom(ƒ_{d}), x≦ƒ_{d}⁻¹(p_{d})}

x_{d}″={min(x):xεdom(ƒ_{d}), x>ƒ_{d}⁻¹(p_{d})}

or

x_{d}′={max(x):xεdom(ƒ_{d}), x<ƒ_{d}⁻¹(p_{d})}

x_{d}″={max(x):xεdom(ƒ_{d}), x≧ƒ_{d}⁻¹(p_{d})}

Note that the mapping functions ƒ_{d}(x) and ƒ_{d}⁻¹(x) must be proper functions and they must be deterministic.

For example, assume subdivisions of d such that the two d-subdivisions touching the origin are both 1 km wide, and the next two d-subdivisions out are 3 km wide, and so on, such that any d-subdivision is 2 km wider than its nearest neighbor closest to the origin. (See Table 1.)

TABLE 1
an example of non-uniform d-subdivisions

| Quantum (x) | Start (f_{d}(x − 1)) | End (f_{d}(x)) |
|---|---|---|
| −n | −(n − 1)² | −n² |
| . . . | . . . | . . . |
| −3 | −4 | −9 |
| −2 | −1 | −4 |
| −1 | 0 | −1 |
| 1 | 0 | 1 |
| 2 | 1 | 4 |
| 3 | 4 | 9 |
| . . . | . . . | . . . |
| n | (n − 1)² | n² |

Because quanta 201 are contiguous, each quantum's start d-boundary p_{d}′ is the end d-boundary p_{d}″ of the prior d-subdivision (i.e., the immediate neighbor closest to the origin). Equation 11 describes mapping function ƒ_{d}(x) and the inverse mapping function ƒ_{d}⁻¹(x).

$$example mapping functions {f}_{d} ( x ) and {f}_{d}^{- 1} ( x ) \\ {f}_{d} ( x ) = \{ \begin{matrix}x ∈ {ℕ}_{0} : {x}^{2} \\ x ∈ ℤ \backslash {ℕ}_{0} : - {x}^{2}\end{matrix} \\ {f}_{d}^{- 1} ( x ) = \{ \begin{matrix}x \geq 0 : \sqrt{x} \\ x < 0 : - \sqrt{- x}\end{matrix} \qquad Equation 11$$

To determine d-boundaries p_{d}′ and p_{d}″ for a point of interest p 105 whose d-component pa is 464,477.867, first apply the inverse mapping function ƒ_{d}⁻¹(x) to p_{d}. Then quantize the result to the nearest two values x_{d}′ and x_{d}″ in the domain of the mapping function ƒ_{d}(x). Finally, apply the mapping function ƒ_{d}(x) to x_{d}′ and x_{d}″ to get p_{d}′ and p_{d}″. (See Eq. 12.)

$$\begin{matrix}a first example of computing d \text{-} boundaries {p}_{d}^{′} and {p}_{d}^{″} for a d \text{-} component {p}_{d} \\ \begin{matrix} {f}_{d}^{- 1} ( 464 , 477.867 ) = \sqrt{464 , 477.867} \\ \approx 681.526 \\ {x}_{d}^{′} = \{ max ( x ) : x ∈ ℤ , x \leq 681.526 \} \\ = 681 \\ {x}_{d}^{″} = \{ min ( x ) : x ∈ ℤ , x \geq 681.526 \} \\ = 682 \\ {p}_{d}^{′} = {f}_{d} ( 681 ) \\ = {681}^{2} \\ = 463 , 761 km \\ {p}_{d}^{″} = {f}_{d} ( 682 ) \\ = {682}^{2} \\ = 465 , 124 km\end{matrix}\end{matrix} \qquad Equation 12$$

In the previous example, the domain of the mapping function ƒ_{d}(x) is constrained to the set of integers Z. This is recommended, since it intuitively maps to the “index” of the d-subdivision. It is convenient for quantizing, since rounding to integers is efficient. It isn't required, however. Take, for example, the case where one wants to subdivide dimension d such that two d-subdivisions touching the origin are both π cm wide, and the next two d-subdivisions out are 2π cm wide, and so on, such that any d-subdivision is π cm wider than its nearest neighbor closest to the origin, but also such that the d-subdivision “indices” are multiples of π. (See Table 2.)

TABLE 2
an example of non-uniform d-subdivisions
whose indices are not integers

| Quantum (x) | Boundary (g_{d}(x)) |
|---|---|
| −n | $- \frac{n}{2} ( \frac{n}{π} - 1 )$ |
| . . . | . . . |
| −3π | −6π |
| −2π | −3π |
| −π | −π |
| π | π |
| 2π | 3π |
| 3π | 6π |
| . . . | . . . |
| n | $\frac{n}{2} ( \frac{n}{π} + 1 )$ |

Equation 13 describes the mapping functions g_{d}(x) and g_{d}⁻¹(x).

$$example mapping functions {g}_{d} ( x ) and {g}_{d}^{- 1} ( x ) \\ {g}_{d} ( x ) = \{ \begin{matrix}π x : x ∈ {ℕ}_{0} \text{:} & \frac{x}{2} ( \frac{x}{π} + 1 ) \\ π x : x ∈ ℤ \backslash {ℕ}_{0} \text{:} & - \frac{x}{2} ( \frac{x}{π} - 1 )\end{matrix} \\ {g}_{d}^{- 1} ( x ) = \{ \begin{matrix}x \geq 0 \text{:} & \frac{- π + \sqrt{8 π x + {π}^{2}}}{2} \\ x < 0 \text{:} & \frac{π - \sqrt{- 8 π x + {π}^{2}}}{2}\end{matrix} \qquad Equation 13$$

Similar to the previous example, to determine the d-boundaries p_{d}′ and p_{d}″ for a point of interest p 105 whose d-component p_{d} is 464,477.867, first apply the inverse mapping function g_{d}⁻¹(x) to p_{d}. Then quantize the result to the nearest two values x_{d}′ and x_{d}″ in the domain of the mapping function g_{d}(x). Finally, apply the mapping function g_{d}(x) to x_{d}′ and x_{d}″ to get p_{d}′ and p_{d}″. (See Eq. 14.)

$$\begin{matrix} & Equation 14 \\ \begin{matrix}a second example of computing d \text{-} boundaries {p}_{d}^{′} and {p}_{d}^{″} for a d \text{-} component {p}_{d} \\ \begin{matrix} {g}_{d}^{- 1} ( 464 , 477.867 ) = \frac{- π + \sqrt{8 π ( 464 , 477.867 ) + {π}^{2}}}{2} \\ \approx 1 , 706.763 \\ {x}_{d}^{′} = \{ max ( x ) \text{:} π x \text{:} x ∈ ℤ , x \leq 1 , 706.763 \} \\ = 543 π \\ {x}_{d}^{″} = \{ min ( x ) \text{:} π x \text{:} x ∈ ℤ , x \geq 1 , 706.763 \} \\ = 544 π \\ {p}_{d}^{′} = {g}_{d} ( 543 π ) \\ = \frac{543 π}{2} ( \frac{543 π}{π} + 1 ) \\ = 147 , 696 π cm \\ {p}_{d}^{″} = {g}_{d} ( 544 π ) \\ = \frac{544 π}{2} ( \frac{544 π}{π} + 1 ) \\ = 148 , 240 π cm\end{matrix}\end{matrix} & \end{matrix}$$

The mapping functions need not be infinite, nor need they be increasing, nor need they even be continuous, so long as the domain of the inverse mapping function adequately models the space of interest 100. Even discrete mappings are supported. Again, while not required, x is typically an index into an array of discrete values. (See Table 3.)

TABLE 3
an example of a discrete mapping function

| | x | | | | | | | |
|---|---|---|---|---|---|---|---|---|
| | 0 | 1 | 2 | 3 | 4 | 5 | 6 | 7 |
| f_{d}(x) | 0 | 100 | 200 | 300 | 400 | 500 | 600 | 700 |

The inverse mapping ƒ_{d}⁻¹(x) is the inverted array of discrete values. (See Table 4.)

TABLE 4
an example of a discrete inverse mapping function

| | x | | | | | | | |
|---|---|---|---|---|---|---|---|---|
| | 0 | 100 | 200 | 300 | 400 | 500 | 600 | 700 |
| f_{d}⁻¹(x) | 0 | 1 | 2 | 3 | 4 | 5 | 6 | 7 |

Considering the case where p_{d} is 273.15 in the above example, the procedure is similar. First, just as before, find where p_{d} belongs in the inverse mapping ƒ_{d}⁻¹(x). p_{d}′ and p_{d}″ are 200 and 300, respectively. Note that arbitrary discrete mappings can be supported, as long as the inverse mapping is a proper function and is deterministic. (See Table 5.)

TABLE 5
a second example of a discrete mapping function

| | x | | | | | | | |
|---|---|---|---|---|---|---|---|---|
| | 270 | −9 | 556 | 223 | 22 | 308 | −204 | 762 |
| g_{d}(x) | 45 | 3,006 | 17 | 454 | 600 | 44 | 22,250 | 0 |

This is easily accommodated by inverting the mapping array, and sorting the value pairs by the domain of the inverse mapping function (i.e., the range of the mapping function). (See Table 6.)

TABLE 6
a second example of a discrete inverse mapping function

| | x | | | | | | | |
|---|---|---|---|---|---|---|---|---|
| | 0 | 17 | 44 | 45 | 454 | 600 | 3,006 | 22,250 |
| g_{d}⁻¹(x) | 762 | 556 | 308 | 270 | 223 | 22 | −9 | −204 |

Again considering the case where p_{d} is 273.15, after sorting, the procedure is identical to the previous example. First, we find where p_{d} belongs in the inverse mapping. p_{d}′ and p_{d}″ are 45 and 585, respectively. Code Listing 5 presents one approach to handling discrete maps that treats the lower bound as inclusive and the upper bound as exclusive.

Code Listing 5: Pythonic pseudocode for computing an inverse
map f_{d}⁻¹(x) related to a discrete map f_{d}(x) in a dimension d,
and for quantizing a d-component of a point of interest
p_{d} into d-boundaries p_{d}′ and p_{d}″

```
import operator
def inverseMap(a_map_d):
    # Takes a list of tuples [ ( x, f(x) ), ... ] and returns a
    # new list [ ( f(x), x ), ... ] sorted on f(x)
    inv_map_d = [ ( i[1], i[0] ) for i in a_map_d ]
    inv_map_d.sort()
    return inv_map_d
def findBounds(a_inv_map_d, a_p_d, a_b = None):
    # Check to see if we're being called from the top level, in
    # which case, set up the bounds and recurse
    if a_b is None:
        len_map_d = len(a_inv_map_d)
        s = findBounds(a_inv_map_d, a_p_d, \
            a_b = ( 0, len_map_d ))
        if s >= len_map_d \
                or s < 0:
            return None
        return s, s + 1
    s, e = a_b
    w = e − s
    # Implement a binary search to find the lower bound
    if w > 1:
        w = w / 2
        # Look left
        if a_inv_map_d[s + w][0] > a_p_d:
            return findBounds(a_inv_map_d, a_p_d, \
                a_b = ( s, s + w ))
        # Look right
        if a_inv_map_d[s + w][0] < a_p_d:
            return findBounds(a_inv_map_d, a_p_d, \
                a_b = ( s + w, e ))
    if a_inv_map_d[s][0] > a_p_d:
        return s − 1
    try:
        if a_inv_map_d[e][0] <= a_p_d:
            return s + 1
    except IndexError:
        return e
    return s
map_d = [ ( 270, 45 ), ( −9, 3006 ), ( 556, 17 ), ( 223, 454 ), \
    ( 22, 600 ), ( 308, 44 ), ( −204, 22250 ), ( 762, 0 ) ]
inv_map_d = inverseMap(map_d)
print findBounds(inv_map_d, 273.15)
```

In modeling an n-dimensional space of interest 100, each dimension d may have a distinct mapping function ƒ_{d}(x) (and inverse mapping function ƒ_{d}⁻¹(x)). Collectively, the mapping functions {[ƒ₁(x), ƒ₁⁻¹(x)], . . . , [ƒ_{d}(x), ƒ_{d}⁻¹)], . . . , [ƒₙ(x), ƒₙ⁻¹)]} are used to compute the boundaries of the quanta. For a point of interest p 105 having n components, boundaries {[p₁′, p₁″], . . . , [p_{d}′,p_{d}″], . . . , [pₙ′,pₙ″]} are computed for each component [p₁, . . . ,p_{d}, . . . ,pₙ] by applying the respective mapping functions as described above. The set of p's home vertices 204 is the n-ary Cartesian product {p₁′,p₁″}× . . . ×{p_{d}′,p_{d}″}× . . . ×{pₙ′,pₙ″}.

### Cubic Quantization as a Subset of N-Quantization

Revisiting Cubic Quantization as a special case of N-Quantization, the generalization holds perfectly. Specifically, the mapping function c_{d}(x), which maps a d-subdivision x to its d-boundary, and the inverse mapping function c_{d}⁻¹(x), which maps a d-boundary to its d-subdivision, are simple linear relationships in terms of a nonzero scalar a, which corresponds to the edge length of each cube (e.g., 100 km). d-boundaries p_{d}′ and p_{d}″ are trivial to compute. Equation 15 describes one embodiment that includes the lower bound and excludes the upper bound. Equation 16 describes the specific case where a is one (i.e., the quanta are unit cubes).

$$\begin{matrix}deriving Cubic Quantization in terms of N \text{-} Quantization \\ {c}_{d} ( x ) = \{ x ∈ ℤ : a x \\ {c}_{d}^{- 1} ( x ) = \{ x ∈ ℝ : \frac{1}{a} x \\ {x}_{d} = \{ max ( {x}^{′} ) : x ∈ ℤ , x \leq \frac{1}{a} {p}_{d} \} \\ {x}_{d} = \{ min ( {x}^{″} ) : x ∈ ℤ , x > \frac{1}{a} {p}_{d} \} \\ {p}_{d}^{′} = {ax}_{d}^{′} \\ {p}_{d}^{″} = {ax}_{d}^{″} & Equation 15 \\ Cubic Quantization for a unit cube & Equation 16 \\ \begin{matrix} {c}_{d} ( x ) = \{ x ∈ ℤ : x \\ {c}_{d}^{- ′} ( x ) = \{ x ∈ ℤ ; x \\ {x}_{d}^{′} = \{ max ( x ) : x ∈ ℤ , x \leq {p}_{d} \} \\ = floor ( {p}_{d} ) \\ {x}_{d}^{″} = \{ min ( x ) : x ∈ ℤ , x > {p}_{d} \} \\ = {x}_{d}^{′} + 1 \\ {p}_{d}^{′} = floor ( {p}_{d} ) \\ {p}_{d}^{″} = {p}_{d}^{′} + 1\end{matrix} & \end{matrix}$$

### When a Point of Interest Falls “Between” Cells

An ambiguity exists when a point of interest p 105 falls on an interface “between” or shared by cells 201 (e.g., a face, edge, or vertex 202). There are at least three options to resolve this ambiguity. Selecting one is application dependent.

First, one treats the shared face, edge, or vertex 202 as belonging to all cells 201 which share it, in which case p has as many home cells 203. p's home vertices 204 would be the set of unique vertices belonging to any of p's home cells 203. This tends to expand the number of adjacent cells 205 (and with it, the potential number of other points considered “near” p).

Second, one treats the face, edge, or vertex 202 itself as the home cell 203. p's home vertices 204 would be those belonging to the face, edge, or vertex 202. This tends to reduce the number of adjacent cells 205.

Third, one selects exactly one home cell 203 for p, even where p fell on a face, edge, or vertex 202. The method of selecting which cell 201 is designated as the home cell 203 for p is not necessarily of great concern, so long as it is deterministic (i.e., it chooses the same home cell 203 each time for p). Purists will likely want to devise a method that does not favor one cell over another. This can be likely be done relatively easily for applications with simple models, for example by including one boundary and excluding another of each subdivision as described above.

Note that in both the first and third cases, “far” faces, edges, or vertices of adjacent cells 205 (i.e., those which do not share any vertices with p's home cell 203) are considered “near”. However, in the second case, this is not true. FIG. 2 depicts some differences. Where p does not coincide with a face, edge, or vertex in either the first or third case 80, points along “far” faces, edges, and vertices are considered “near”. In the second case 90, they are not. In the second case, where p coincides with an edge 91, the number of adjacent cells is reduced. Where p coincides with a vertex 92, the number of adjacent cells is further reduced. Code Listing 6 depicts aspects of the first and second cases for one embodiment:

Code Listing 6: Pythonic pseudocode to show inclusive and
exclusive versions of quantization functions with differences
underlined

```
def quantizeInclusive(a_v, a_m):
    ″″″
    >>> quantize(0, 1)
    [−1, 0, 1]
    >>> quantize(−10, 1)
    [−11, −10, −9]
    >>> quantize(0.25, 1 / 2)
    [0.0, 0.5]
    >>> quantize(105, 50)
    [100, 150]
    >>> quantize(−105, 50)
    [−150, −100]
    ″″″
    quantized = int(a_v / a_m)
    # Note: use of the modulo operator (%) is theoretical; in
    # reality, one will likely have to carefully accommodate
    # floating point errors
    if a_v % a_m == 0:
        return [ (quantized − 1) * a_m, quantized * a_m, \
            (quantized + 1) * a_m ]
    if a_v < 0:
        return [ (quantized −1) * a_m, quantized * a_m ]
    # a_v >= 0
    return [ quantized * a_m, (quantized + 1) * a_m ]
def quantizeExclusive(a_v, a_m):
    ″″″
    >>> quantize(0, 1)
    [0]
    >>> quantize(−10, 1)
    [−10]
    >>> quantize(0.25, 1 / 2)
    [0.0, 0.5]
    >>> quantize(105, 50)
    [100, 150]
    >>> quantize(−105, 50)
    [−150, −100]
    ″″″
    quantized = int(a_v / a_m)
    # Note: use of the modulo operator (%) is theoretical; in
    # reality, one will likely have to carefully accommodate
    # floating point errors
    if a_v % a_m == 0:
        return [ quantized * a_m ]
    if a_v < 0:
        return [ (quantized − 1) * a_m, quantized * a_m ]
    # a_v >= 0
    return [ quantized * a_m, (quantized + 1) * a_m ]
```

### Data Storage and Retrieval of Home Vertices

To facilitate efficient storage in and retrieval from a data store 534, the n cartesian components of each of the m total home vertices v₁, . . . , vᵢ, . . . , vₘ 204 for the home cell V of a point of interest 105 are encoded as a Morton number ωᵢ unique to that vertex. (See Eq. 17.)

$$home vertices as Morton numbers \\ \begin{matrix}V = \{ {\vec{v}}_{1} , … , {\vec{v}}_{i} , … , {\vec{v}}_{m} \} \\ = \{ [ \begin{matrix}{v}_{{1}_{1}} \\ ⋮ \\ {v}_{{1}_{j}} \\ ⋮ \\ {v}_{{1}_{n}}\end{matrix} ] , … , [ \begin{matrix}{v}_{{i}_{1}} \\ ⋮ \\ {v}_{{i}_{j}} \\ ⋮ \\ {v}_{{i}_{n}}\end{matrix} ] , … , [ \begin{matrix}{v}_{{m}_{1}} \\ ⋮ \\ {v}_{{m}_{j}} \\ ⋮ \\ {v}_{{m}_{n}}\end{matrix} ] \} \\ {ω}_{i} = mort ( {\vec{v}}_{i} ) \\ = mort ( {v}_{{i}_{1}} , … , {v}_{{i}_{j}} , … , {v}_{{i}_{n}} ) \\ {home}_{ω} ( V ) = \{ {ω}_{1} , … , {ω}_{i} , … , {ω}_{m} )\end{matrix} \qquad Equation 17$$

Technically, Morton numbers have some favorable characteristics (e.g., near points tend to be clustered when sorting), but they are not strictly necessary. Any mechanism that efficiently indexes a unique set of scalars without ambiguity is sufficient. For example, fixed-width bit fields representing each d-component in a vertex could be concatenated rather than interleaved.

By allowing nearness comparisons to be based on intersection of common values, the mechanisms provide a vastly more efficient means for retrieval than traditional methods because comparisons are direct or equality-based rather than range- or inequality-based. For example, this allows range selection for another property in Google's App Engine. (See Code List. 7.)

Code Listing 7: GQL pseudocode for selecting records whose
points are “near” to p, while also selecting on a range
for another attribute

-- This will FAIL: it attempts to select records based on ranges
-- of more than one property (i.e., latitude and longitude)
SELECT *
FROM Points
WHERE latitude >= ...
AND latitude < ...
AND longitude >= ...
AND longitude < ...
-- This will succeed: get all records in Points that share any
-- home vertices with ω₁, ..., ωᵢ, ..., ωₘ, and who have a decent
-- user rating
SELECT *
FROM Points
WHERE home_vertices IN ( ω₁, ..., ωᵢ, ..., ωₘ )
AND user_rating >= 2.5
-- This will also succeed: get all records in Points that share
-- any home vertices with ω₁, ..., ωᵢ, ..., ωₘ, ordered by the
-- most-to-least recent
SELECT *
FROM Points
WHERE home_vertices IN ( ω₁, ..., ωᵢ, ..., ωₘ )
ORDER BY point_date DESC

One embodiment provides a means for a user to store a point of interest 105 in n-space with related data, where set(s) of home vertices 204 are computed from the point of interest 105 to be stored. A schema is defined in a storage engine 532 indicating what (if any) data is to be associated with each point of interest 105. The storage engine 532 also defines the model for computing the home vertices 204 to be associated with the point of interest 105 to be stored, as well as the internal representation of each home vertex 204 (e.g., as Morton numbers). When a storing user submits a point of interest 105 and any associated data for storage, the data is verified against the schema, the home vertices 204 are computed from the submitted point of interest 105, a point record 537 is created, and the submitted point of interest 105, submitted data, and home vertices 204 are associated with the point record 537 in the data store 534 (e.g., as a single record, or set of associated records). Code Listing 8 depicts aspects of one such embodiment.

Code Listing 8: SQL-like pseudocode defining a schema
in which a URL and a date may be associated with a
point of interest, and where there are four models
used to compute the set of home vertices

```
CREATE TABLE home_vertex_types (
    id INTEGER PRIMARY KEY,
    desc TEXT
);
INSERT INTO home_vertex_types VALUES
( 1, ‘cubic quantized 100 m’ ),
( 2, ‘cubic quantized 1 km’ ),
( 3, ‘cubic quantized 10 km’ ),
( 4, ‘cubic quantized 100 km’ );
CREATE TABLE point_records (
    id INTEGER PRIMARY KEY,
    point_of_interest INTEGER,
    point_date INTEGER,
    url TEXT,
    ...
);
CREATE TABLE home_vertices (
    point_record_id INTEGER,
    home_vertex_type_id INTEGER,
    vertex_val INTEGER,
    FOREIGN KEY (point_record_id)
        REFERENCES point_record(id),
    FOREIGN KEY (home_vertex_type_id)
        REFERENCES home_vertex_type(id)
);
```

The point of interest p 105 need not necessarily be submitted explicitly in the new record request 536, but can be extracted, calculated, or inferred from other data in that request. For example, many digital cameras (including those integrated into mobile phones) have the ability to “know” their location (e.g., via GPS, A-GPS, etc.). Many encode the location of the camera (if it is known) in a digital image file that is created when a photo is taken. Among the most popular ways to encode such data is via “exchangeable image file format” (Exif) information. In one embodiment, the storage engine 532 looks for such embedded location data and use that data as the point of interest 105 instead of requiring a submitting user to identify it explicitly.

Another embodiment provides a means for a retrieving user to specify criteria identifying a subset of all point records 537, and to retrieve data associated with those point records 537. The retrieving user submits matching criteria to a retrieval engine 533. The matching criteria specify zero or more constraints on the point records 537 or associated data with at least one arbitrary point of interest 105 that the points 206 corresponding to the subset of point records 537 must be “near”. Home vertices 204 are computed for the arbitrary point of interest 105 using the same calculation model used when submitting points 206 using the storage engine 532. Requested data from point records 537 in the data store that share at least one home vertex 208 with the home vertices 204 computed from the arbitrary point of interest 105, and which meet any other specified criteria, are transmitted to the retrieving user along with any requested data associated with those point records 537. Code Listing 9 depicts aspects of one such embodiment.

Code Listing 9: SQL-like pseudocode for retrieving
from a schema in which a URL and a date may be
associated with a point of interest

-- Get the URLs associated with points who share at least one
-- home vertex with the given vertices in the “cubic quantized 1
-- km” model and order the results by newest first
SELECT pr.url
FROM point_records pr
INNER JOIN home_vertices hv
ON hv.point_record_id = pr.id
WHERE hv.vertex_val IN ( ω₁, ..., ωᵢ, ..., ωₘ )
AND hv.home_vertex_type_id = 2
ORDER BY pr.point_date DESC;

Another embodiment relates to storage and retrieval of points in 3-space which exist on the surface of a solid approximating a spherical object (like a planet). The spherical object is approximated by a non spherical surface made up of discrete faces (e.g., a Platonic solid or subdivision or tessellation thereof). During storage, the enclosing face on the solid is determined for the point submitted by a storing user, projecting the point onto the face if necessary. The home vertices 204 are associated with the point record 537. During retrieval, the same calculation is applied to an arbitrary point submitted by a retrieving user. Points retrieved will share at least one home vertex with the arbitrary point submitted.

Another embodiment relates to storage and retrieval of points in n-space based on shapes whose edges are all equal in length (e.g., line segment, square, cube, hypercube, etc.). During storage, the enclosing shape is determined for the point submitted by a storing user. The home vertices 204 are associated with the point record 537 as encoded representations. During retrieval, the same calculation is applied to an arbitrary point submitted by a retrieving user. Points retrieved will share at least one vertex with the arbitrary point submitted. In yet another embodiment, edge lengths and angles may not be uniform, (e.g., line segments whose lengths are a function of a distance away from a reference point, rectangles, quadrilateral, n-quadrilaterally-faced hexahedra, etc.).

In many embodiments, computing the home vertices 204 is a function performed by the storage engine 532. However, there are applications where it is advantageous to perform the computation elsewhere. In one embodiment, the calculation model is left to the submitting and retrieving users, in which case the computed home vertices 204 are submitted with the new record request 536 or matching criteria, and are subsequently associated with the point record 537 in the data store 534.

Note that variations and combinations are possible. For example, points from concurrent models may be retrieved simultaneously. Data associated with points which are “near” more than one point may be retrieved simultaneously. (See, e.g., Code List. 10.)

Code Listing 10: SQL-like pseudocode for various
retrieval scenarios

```
-- Get the URLs associated with points who share at least one
-- home vertex with the given vertices in both the “cubic
-- quantized 1 km” and “cubic quantized 10 km” models
SELECT pr.url, hv.home_vertex_type_id
FROM point_records pr
INNER JOIN home_vertices hv
ON hv.point_record_id = pr.id
WHERE (hv.vertex_val IN ( ω1₁, ..., ω1ᵢ, ..., ω1ₘ )
    AND hv.home_vertex_type_id = 2)
OR (hv.vertex_val IN ( ω2₁, ..., ω2ᵢ, ..., ω2ₘ )
    AND hv.home_vertex_type_id = 3);
-- Get the URLs associated with points who share at least one
-- home vertex with at least one set of given vertices calculated
-- from submitted points of interest p₃ and p₄, in the “cubic
-- quantized 100 km” model (i.e., “nearness” union)
SELECT pr.url
FROM point_records pr
INNER JOIN home_vertices hv
ON hv.point_record_id = pr.id
WHERE hv.vertex_val IN ( ω3₁, ..., ω3ᵢ, ..., ω3ₘ, ω4₁, ..., ω4ᵢ, ..., ω4ₘ )
AND hv.home_vertex_type_id = 4;
-- Get the URLs associated with points who share at least one
-- home vertex with both sets of given vertices calculated from
-- submitted points of interest p₃ and p₄, in the “cubic quantized
-- 100 km” model (i.e., “nearness” intersection)
SELECT pr.url
FROM point_records pr
INNER JOIN home_vertices hv
ON hv.point_record_id = pr.id
WHERE hv.vertex_val IN ( ω3₁, ..., ω3ᵢ, ..., ω3ₘ )
AND hv.vertex_val IN ( ω4₁, ..., ω4ᵢ, ..., ω4ₘ )
AND hv.home_vertex_type_id = 4;
```

Another embodiment relates to associating more than one set of home vertices 204 with each point record 537 in the data store 534, where each set of home vertices 204 represents a single calculation model. For example, multiple sets of home vertices 204 could allow for multiple types or sizes of cells 201 (e.g., multiple distances, such as one set for 1 m, one for 10 m, 100 m, 1 km, etc.) to be associated with each point record 537 concurrently. During storage, multiple home cells 203 are computed for the point of interest 105 submitted by a storing user. The sets of home vertices 204, each set corresponding to each home cell 203, are associated with the new point record 537. During retrieval, a retrieving user designates which set(s) of home vertices 204 are relevant to the query.

With various embodiments, any number of sets of home vertices 204 may be associated with each point record 537. This allows for the retrieval of “near” points within any defined calculation model. Multiple sets can exist simultaneously, so the same data store 534 may be used to retrieve point records 537 within many sets without significantly affecting efficiency. Additional sets may be computed and stored at any time, since they are based on data already associated with each point record 537. This allows modification of a schema defining two sets (e.g., one representing 1 km, and one 100 km). Assuming the data store 534 is populated with many point records 537, a third set (e.g., 10 km) could later be added. Home vertices 204 for the third set are computed for and associated with each point record 537 in the data store 534. The storage engine 532 is updated to include computation or receipt of the third set of home vertices 204 in addition to the other two. From then on new records 537 for newly-submitted points of interest 105 submitted by storing users would acquire all three sets, and retrieving users would be able to use the third set in their queries. (See, e.g., Code List. 11.)

Code Listing 11: SQL-like pseudocode to support additional
calculation models in an existing schema (does not include
any required modifications to the storage engine)

INSERT INTO home_vertex_types VALUES
( 5, ‘QBT icosahedron 30,543 subdivisions’ ),
( 6, ‘QBT icosahedron 3,054 subdivisions’ ),
( 7, ‘QBT icosahedron 305 subdivisions’ ),
( 8, ‘QBT icosahedron 30 subdivisions’ );
-- For every record in point_records, calculate and insert new
-- values in home_vertices to support the newly-added
-- home_vertex_types
...

FIG. 10 shows a block diagram of components that may be present in devices and computer systems that implement aspects of the invention. Additional or fewer components may exist in any individual device. Nevertheless, FIG. 10 is fairly representative.

A central processing unit (CPU) bus 501 allows the various components of the computing device to communicate. A CPU 502 executes instructions or computer code which can be stored in a memory subsystem 503. The memory subsystem 503 represents what is typically volatile memory. A network subsystem 504 allows the computing device or computer system to communicate over a network. A storage subsystem 505 is responsible for nonvolatile storage of computer code and data. Representative storage media include a hard drive 506, a solid state storage 131, etc.

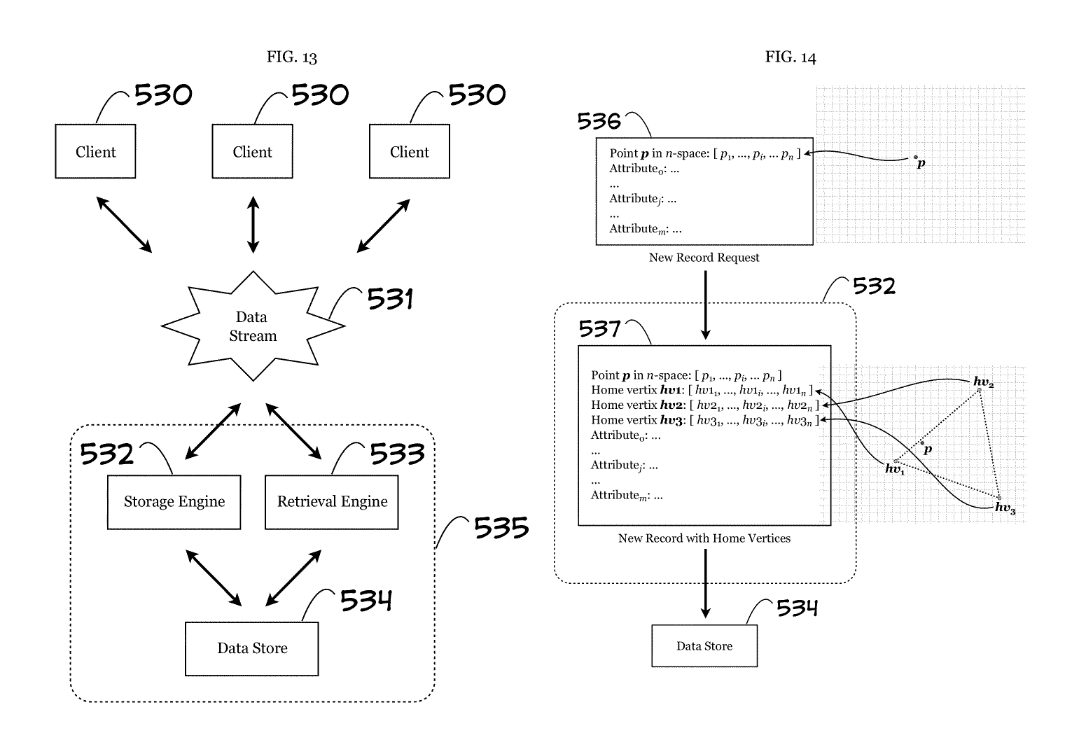

FIG. 13 shows a block diagram of one embodiment within the context of a network. A client 53o interacts through a data stream 531 with a server or collection of distributed servers 535. The data stream 531, like all network representations shown herein, can be any channel that allows devices to communicate, including a computer network, aloopback device, a pipe or other shared memory, a proprietary network, the Internet, etc., and can be made available using any query mechanism, open or proprietary (e.g., direct API calls, REST, SOAP, XML-RPC, JSON-RPC, HTTP GET/POST, RSS/ATOM, SDF, Elasticsearch or other search APIs, ODBC, SQL, GQL, proprietary database APIs, etc.). Code Listing 12 depicts aspects of an example embodiment in which a client makes a request via HTTP GET with a latitude (“lat”), a longitude (“lon”), a calculation model (“a”), and a sort order (“-updated”) among its matching criteria.

Code Listing 12: pseudo-code depicting an exchange between
a client using an HTTP/GET query to retrieve entries “near”
a given “lat”/“lon” point in the format of an ATOM feed
with GeoRSS extensions

```
GET /near?lat=37.25&lon=−115.80&a=10km&sort=-updated HTTP/1.1
Host: abcd.dom:80
...
HTTP/1.1 301 Moved Permanently
Location: http://abcd.dom/10km/06050003928000dd/?sort=-updated
GET /10km/06050003928000dd/?sort=-updated HTTP/1.1
Host: abcd.dom:80
...
HTTP/1.1 200 OK
Date: Sat, 13 Mar 2010 03:48:26 GMT
Content-Type: application/atom+xml
...
<?xml version=“1.0” encoding=“utf-8”?>
<feed xmlns=“http://www.w3.org/20 05/Atom”
    xmlns:geo=“http://www.georss.org/georss/”>
  <title>Entries Near (10km/06050003928000dd)</title>
  <link href=“http://abcd.dom/10km/06050003928000dd/...” />
  <updated>2010-03-12T18:30:02Z</updated>
  <id>tag:abcd-dom:10km:06050003928000dd:-updated</id>
  ...
  <entry>
    <title>Tailgatin' with Bob the Alien - Pt. 2</title>
    <link href=“...”/>
    <id>tag:...</id>
    <updated>2010-03-12T20:30:02Z</updated>
    <author>
      <name>Julien Rome</name>
    </author>
    <geo:point>37.239073 −115.8136984</geo:point>
    <summary>
      Bob is CUH-RAY-ZEE! I snapped this right after he downed
      his SEVENTEENTH CASE of Stolichnaya. I don't know where he
      puts it, but these guys have amazing metabolisms!
    </summary>
    <content type=“image/png” src=“http://.../bob2.png” />
    ...
  </entry>
  <entry>
    <title>Tailgatin' with Bob the Alien</title>
    <link href=“...”/>
    <id>tag:...</id>
    <updated>2010-03-12T18:05:47Z</updated>
    <author>
      <name>Julien Rome</name>
    </author>
    <geo:point>37.239078 −115.8136987</geo:point>
    <summary>
      Check me out having BBQ with Bob the Alien. This guy has an
      AWESOME sauce recipe!
    </summary>
    <content type=“image/png” src=“http://.../bob.png” />
    ...
  </entry>
  ...
</feed>
```

In the example embodiment, the server determines a home cell unique identifier from the client-submitted latitude/longitude pair and calculation model. It redirects the client to a “standardized” location, using the calculation model (“10 km”) and the home cell unique identifier (“06050003928000dd”).¹⁰ This type of redirection approach is not strictly necessary, but it can often be helpful for feed aggregators and caching servers. ¹⁰ In the depicted embodiment, as one might guess, the calculation model is Cubic Quantization with edge lengths of m km, and the unique identifier is merely the Morton number of [p₁′,p₂′,p₃′] for the home cell. However, this is an implementation detail. The only constraint on unique identifiers is that they must be unique to a home cell in a calculation model. Any method that guarantees these constraints will suffice.

After the client performs the redirect request, the server responds with XML data corresponding to an ATOM feed comprising GeoRSS extensions. The feed contains entries whose associated home cells coincide with or border on home cell 06050003928000dd. These are “near” the client-submitted latitude/longitude pair at a “precision” of 10 km (i.e., using a particular calculation model). The entries are sorted inversely by “updated” date, as requested by the client. Details of network transport, user authentication, back-end data store schema, implementation, and interaction, etc., have been omitted for simplicity, but should be apparent to one skilled in the art.

The above example is particularly interesting because the steps of resolving a point of interest (“ . . . lat=37.25&lon=−115.80 . . . ”) to a particular home cell in a particular calculation model (“ . . . /10 km/06050003928000dd/ . . . ”), and the steps of retrieving data associated with point records whose points whose home cells coincide with or border on that home cell (via the ATOM feed), are broken up into more than one client/server round trip, which is very much contemplated by the invention. In some cases, the server performing the home cell resolution could be completely different (and accessed by a completely different protocol) than the server providing the feed. (See, e.g., Code List. 13.)

Code Listing 13: pseudo-code depicting an exchange where
the server which performs the home cell calculation and
redirect is different from the server providing data
associated with “near” points; notable differences
from Code List. 12 are underlined

```
      GET /near?lat=37.25&lon=−115.80&a=10km HTTP/1.1
      Host: abcd.dom:80
      ...
HTTP/1.1 301 Moved Permanently
Location: https://wxyz.dom/10km/06050003928000dd/
GET /10km/06050003928000dd/ HTTP/1.1
Host: wxyz.dom:443
...
HTTP/1.1 200 OK
Date: Sat, 13 Mar 2010 03:48:26 GMT
Content-Type: application/atom+xml
...
<?xml version=“1.0” encoding=“utf-8”?>
  ...
```

Note it is also possible (and sometimes advantageous) for the client 53o and the server 535 to reside on the same physical machine, although typically the components identified in FIG. 13 are distributed among two or more (sometimes many more) machines as alluded to above. The server 535 consists of a storage engine 532 and a retrieval engine 533. The storage engine 532 and retrieval engine 533 may be independent components, or they may exist as part of a larger component (e.g., one that is exposed through a single Application Programmer's Interface [API]).

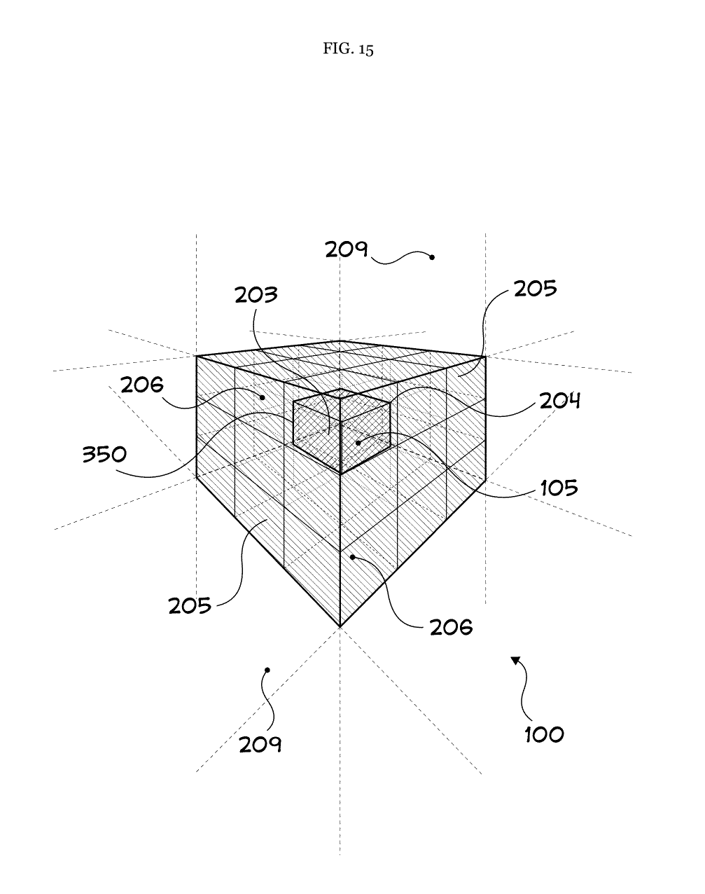

The storage engine 532 interacts with a data store 534 to store an arbitrary set of points of interest 105 in an n-dimensional space of interest 100 as point records 537, along with one or more sets of home vertices 204 and any arbitrary data to be associated with each point record 537. This process is illustrated in more detail in FIGS. 11 and 14.

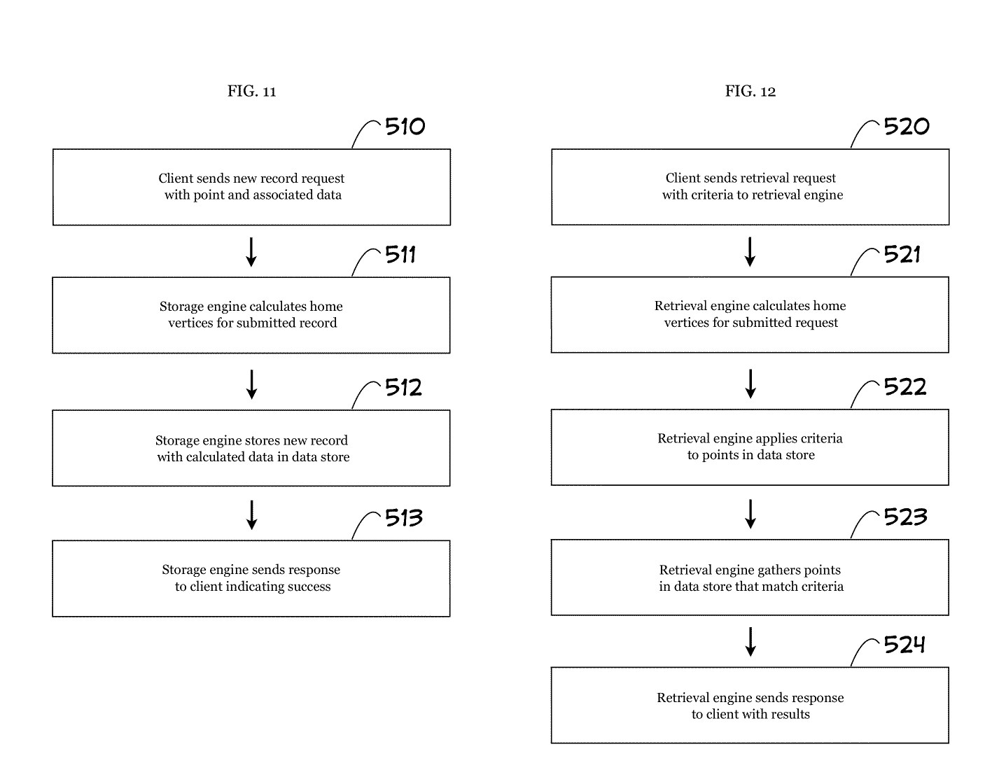

The retrieval engine 533 receives arbitrary matching criteria from the client 53o. The retrieval engine 533 interacts with data store 534 to perform queries that match point records 537 stored via the data store 534 against the arbitrary criteria received from the client 53o. The retrieval engine 533 retrieves data associated with any matched point records 537 via the data store 534 and sends the results to the client 530. This process is illustrated in more detail in FIG. 12.

FIG. 11 shows a flowchart of a process of one embodiment to store new point records 537 in the data store 534. As with all flowcharts shown herein, steps can be added, deleted, combined, and reordered without departing from the spirit and scope of the invention.

At step 510, the client 53o makes a new record request 536. The new record request 536 contains an arbitrary point of interest 105 in an n-dimensional space of interest 100 and an arbitrary set of data associated with that point of interest 105.

At step 511, the storage engine 532 calculates the set(s) of home vertices 204 for the point of interest 105 submitted as part of the new record request 536.

At step 512, the storage engine 532 creates a point record 537 in the data store 534, and associates with it the point of interest 105, the set(s) of home vertices 204 calculated in step 511.

At step 513, the storage engine 532 (optionally) sends a response to the client indicating to success.

FIG. 12 shows a flowchart of a process of one embodiment to retrieve point records 537 or associated data from the data store 534 that match arbitrary criteria.

At step 520, the client 53o makes a request to the retrieval engine 533. The request includes matching criteria, including an arbitrary point of interest 105 in an n-dimensional space of interest 100.

At step 521, the retrieval engine 533 calculates the set(s) of home vertices 204 for the point of interest 105 submitted as part of the request from step 520.

At step 522, the retrieval engine 533 retrieves point records 537 from the data store 534 that match the criteria and share any home vertices 208 with the home vertices 204 calculated in step 520.

In alternate embodiments, more complex criteria matching home vertices 204 or other data associated with the point records 537 may be described in the request. As a nom-limiting example, embodiments may allow the client 53o to use boolean logic and other operators (e.g., comparative operators like ≦ and >, string matching operators like “begins-with” or “contains”, etc.). This is not an exhaustive list. It is merely illustrative of providing the ability to express complex queries using arbitrary expressions.

At step 523, the retrieval engine 533 gathers data responsive to the query and associated with the zero or more point records 537 identified in step 522.

At step 524, the data responsive to the query identified in step 523 is sent to the client.

In alternative embodiments, the client 53o may specify schema definitions along with matching criteria to narrow the data retrieved in step 522 or returned in step 523 so that not all corresponding data is sent to the client 530. This could be in the form of a limit on the number of records returned, ordering specifications, or an inclusionary or exclusionary list of the types, names, etc., of any associated data to either return or omit.

FIG. 14. shows a block diagram of an embodiment of the storage of points in a data store. The client 53o sends new record request 536 consisting of a point of interest 105 in an n-dimensional space of interest 100, and any corresponding data to the storage engine 532. The storage engine 532 calculates the set(s) of home vertices 204 for the point of interest 105 submitted as part of the new record request 536. The storage engine 532 instructs the data store 534 to create a point record 537 and associate with it the set(s) of home vertices 204. Retrieval is illustrated in more detail in FIG. 12.

### INDUSTRIAL APPLICABILITY

The invention pertains to efficiently determining nearness of points in n-space, storage and retrieval of such points in a data store, as well as any industry where that may be of value or importance.

1-22. (canceled)

23. A method for storing geo-location data, including a set of N-Quantized home vertices of a point p; said point p being defined in a cartesian coordinate system; the method comprising the steps:
a. computing said set of N-Quantized home vertices from said point p;
b. creating a point record for storage in a non-transitory memory; and
c. associating said point p and the set of N-Quantized home vertices with said point record.

24. The method of claim 23 further comprising the step of encoding as a Morton number one of:
a. said point p; and
b. a member of said set of N-Quantized home vertices.

25. A method for retrieving geo-location data related to a set of N-Quantized home vertices of a point q; said point q being defined in a cartesian coordinate system; the method comprising:
a. computing said set of N-Quantized home vertices from said point q;
b. identifying point records in a non-transitory memory with which at least one member of said set of N-Quantized home vertices is associated.

26. The method of claim 25 further comprising the step of encoding as a Morton number one of:
a. said point q; and
b. a member of said set of N-Quantized home vertices.

27. A method for performing operations on n-space geo-location data in a normalized coordinate system, the method comprising the steps:
a. receiving one or both of:
i. a storage command comprising an input record; and
ii. a retrieval command comprising matching criteria;
b. upon receiving said storage command:
i. calculating from or identifying in said input record a point p;
ii. calculating from said point p or said input record, or identifying in said input record a set of home vertices P a set of home vertices P defining a shape that includes said point p;
iii. creating a point record in said non-transitory memory; and
iv. associating a member of said set of home vertices P with said point record;
c. upon receiving said retrieval command:
i. calculating from or identifying in said matching criteria a point q;
ii. calculating from said point q or said matching criteria, or identifying in said matching criteria a set of home vertices Q a set of home vertices Q defining a shape that includes said point q; and
iii. identifying in said non-transitory memory a point record associated with a member of said set of home vertices Q.

28. The method of claim 27, where:
a. said normalized coordinate system comprises a triangle ΔTₚ and a triangle ΔT_{q};
b. said point p or a projection of said point p is coplanar with and is included by said triangle ΔTₚ;
c. said set of home vertices P defines a sub-triangle ΔTₚ′, which is calculated by applying Quantized Barycentric Triangulation to said triangle ΔTₚ and said point p or said projection of said point p.
d. said point q or a projection of said point q is coplanar with and is included by said triangle ΔT_{q};
e. said set of home vertices Q defines a sub-triangle ΔT_{q}′, which is calculated by applying Quantized Barycentric Triangulation to said triangle ΔT_{q} and said point q or said projection of said point q.

29. The method of claim 27, where:
a. said normalized coordinate system comprises an n-dimensional cartesian coordinate system, n being a natural number greater than zero;
b. said set of home vertices P is calculated by applying N-Quantization to said point p; and
c. said set of home vertices Q is calculated by applying N-Quantization to said point q.

30. The method of claim 27, where the steps further comprise encoding as a Morton number one or more of:
a. said point p;
b. said point q;
c. said member of said set of home vertices P; and
d. said member of said set of home vertices Q.

31. The method of claim 27, where:
a. said input record comprises digital media or a reference to digital media;
b. said digital media comprise metadata; and
c. said point p is calculated from or identified in said metadata.

32. The method of claim 27, where:
a. said input record comprises a reference or pointer to data;
b. said input record does not comprise said data; and
c. said point p is calculated from or identified in said data.

33. The method of claim 32, where said reference to said data comprises a URL.

34. A system for storing geo-location data, including a set of N-Quantized home vertices of a point p; said point p being defined in a cartesian coordinate system; the system comprising:
a. a computer processor configured to compute said set of N-Quantized home vertices from said point p; and
b. a data store in electronic communication with said computer processor, said data store for:
i. creating a point record in a non-transitory memory; and
ii. associating said point p and said set of N-Quantized home vertices with said point record.

35. The system of claim 34, where the computer processor is further configured to encode as a Morton number one of:
a. said point p; and
b. a member of said set of N-Quantized home vertices.

36. A system for retrieving geo-location data related to a set of N-Quantized home vertices of a point q; said point q being defined in a cartesian coordinate system; the system comprising:
a. a computer processor configured to compute said set of N-Quantized home vertices from said point q; and
b. a data store in electronic communication with said computer processor, said data store for identifying point records in a non-transitory memory with which at least one member of said set of N-Quantized home vertices is associated.

37. The system of claim 36, where the computer processor is further configured to encode as a Morton number one of:
a. said point q; and
b. a member of said set of N-Quantized home vertices.

38.

39. A system for performing operations on n-space geo-location data in a normalized coordinate system, the system comprising:
a. a command input for receiving one or both of:
i. a storage command comprising an input record; and
ii. a retrieval command comprising matching criteria;
b. a non-transitory memory for storing or retrieving a point record;
c. a computer processor in electronic communication with said non-transitory memory and said command input, said computer processor configured to:
i. upon receiving said storage command:
A. calculate from or identify in said input record a point p;
B. calculate from said point p or said input record, or identify in said input record a set of home vertices P a set of home vertices P defining a shape that includes said point p;
C. create a point record in said non-transitory memory; and
D. associate a member of said set of home vertices P with said point record;
ii. upon receiving said retrieval command:
A. calculate from or identify in said matching criteria a point q;
B. calculate from said point q or said matching criteria, or identify in said matching criteria a set of home vertices Q a set of home vertices Q defining a shape that includes said point q; and
C. identify in said non-transitory memory a point record associated with a member of said set of home vertices Q.

40. The system of claim 39, where:
a. said normalized coordinate system comprises a triangle ΔTₚ and a triangle ΔT_{q};
b. said point p or a projection of said point p is coplanar with and is included by said triangle ΔTₚ;
c. said set of home vertices P defines a sub-triangle ΔTₚ′, which is calculated by applying Quantized Barycentric Triangulation to said triangle ΔTₚ and said point p or said projection of said point p.
d. said point q or a projection of said point q is coplanar with and is included by said triangle ΔT_{q};
e. said set of home vertices Q defines a sub-triangle ΔT_{q}′, which is calculated by applying Quantized Barycentric Triangulation to said triangle ΔT_{q} and said point q or said projection of said point q.

41. The system of claim 39, where:
a. said normalized coordinate system comprises an n-dimensional cartesian coordinate system, n being a natural number greater than zero;
b. said set of home vertices P is calculated by applying N-Quantization to said point p; and
c. said set of home vertices Q is calculated by applying N-Quantization to said point q.

42. The system of claim 39, where said computer processor is further configured to encode as a Morton number one or more of:
a. said point p;
b. said point q;
c. said member of said set of home vertices P; and
d. said member of said set of home vertices Q.

43. The system of claim 39, where:
a. said input record comprises digital media or a reference to digital media;
b. said digital media comprise metadata; and
c. said point p is calculated from or identified in said metadata.

44. The system of claim 39, where:
a. said input record comprises a reference or pointer to data;
b. said input record does not comprise said data; and
c. said point p is calculated from or identified in said data.

45. The system of claim 44, where said reference to said data comprises a URL.

46. Non-transitory computer-readable medium containing a program for causing a computer processor to perform Quantized Barycentric Triangulation of points a, b, c, and p; each of said points a, b, c, and p being defined in a cartesian coordinate system; and said points a, b, and c defining vertices of a triangle ΔT; the program comprising instructions for:
a. computing barycentric coordinate values u, v, and w for said point p in said triangle ΔT;
b. quantizing said barycentric coordinate value u to values u′, u″;
c. quantizing said barycentric coordinate value v to values v′, v″;
d. quantizing said barycentric coordinate value w to values w′, w″; and
e. determining which combinations of said values u′, u″, v′, v″, w′, and w″ define valid barycentric coordinates in said triangle ΔT.

47. The non-transitory computer-readable medium of claim 46, where said instructions for determining which combinations of said values u′, u″, v′, v″, w′, and w″ define valid barycentric coordinates in said triangle ΔT further comprise instructions for computing a parity.
